(19) United States
(12) Patent Application Publication
(10) Pub. No.: US 2023/0268981 A1
(43) Pub. Date: Aug. 24, 2023

(54) METHOD FOR TRANSMITTING, BY NTN, DOWNLINK SIGNAL ON BASIS OF POLARIZATION INFORMATION IN WIRELESS COMMUNICATION SYSTEM, AND APPARATUS FOR SAME

(71) Applicant: LG ELECTRONICS INC., Seoul (KR)

(72) Inventors: Haewook PARK, Seoul (KR); Hyunsoo KO, Seoul (KR); Hyunsu CHA, Seoul (KR); Jaenam SHIM, Seoul (KR)

(73) Assignee: LG ELECTRONICS INC., Seoul (KR)

(21) Appl. No.: 18/018,028

(22) PCT Filed: Aug. 4, 2021
(86) PCT No.: PCT/KR2021/010240

§ 371 Date: Jan. 25, 2023

(30) Foreign Application Priority Data
Aug. 4, 2020 (KR) 10-2020-0097143

(51) Int. Cl. H04B 7/10; H04B 7/185; H04L 5/00

(52) U.S. Cl. CPC H04B 7/10; H04B 7/18513; H04L 5/0048; H04W 84/06

(57) ABSTRACT

Disclosed, in various embodiments, are a method by which a non-terrestrial network (NTN) transmits a downlink signal on the basis of polarization information in a wireless communication system, and an apparatus for same. The method comprises the steps of generating a sequence related to the downlink signal; and transmitting the downlink signal including the sequence, wherein the sequence is sequence initialized on the basis of a parameter related to the polarization information.

### CROSS-REFERENCE TO RELATED APPLICATION(S)

This application is the National Stage filing under 35 U.S.C. 371 of International Application No. PCT/KR2021/010240, filed on Aug. 4, 2021, which claims the benefit of earlier filing date and right of priority to Korean Application No. 10-2020-0097143, filed on Aug. 4, 2020, the contents of which are all incorporated by reference herein in their entirety.

### TECHNICAL FIELD

The present disclosure relates to a method of transmitting, by a non-terrestrial network (NTN), a downlink signal based on polarization information in a wireless communication system and apparatus therefor.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR).

### SUMMARY

The object of the present disclosure is to a method and apparatus for identifying and transmitting downlink signals according to polarization information through sequence initialization based on the polarization information.

It will be appreciated by those of ordinary skill in the art to which the embodiment(s) pertain that the objects that could be achieved with the embodiment(s) are not limited to what has been particularly described hereinabove and the above and other objects will be more clearly understood from the following detailed description.

In an aspect of the present disclosure, there is provided a method of transmitting, by a non-terrestrial network (NTN), a downlink signal based on polarization information in a wireless communication system. The method may include: generating a sequence related to the downlink signal; and transmitting the downlink signal including the sequence. The sequence may be sequence-initialized based on a parameter related to the polarization information.

Alternatively, the polarization information may be information on one of linear polarization, right-handed circular polarization (RHCP), and left-handed circular polarization (LHCP).

Alternatively, the sequence may be sequence-initialized based on the parameter related to the polarization information, 2^{M}λ, where λ is determined as 0 or 1 depending on the polarization information, and M is a positive integer.

Alternatively, a channel state information reference signal (CSI-RS) included in the downlink signal may be generated based on the sequence sequence-initialized according to the following equation:

cᵢₙᵢₜ=(2¹⁰(N_{symb}^{slot}n_{s,f}^{μ}+l+1)(2n_{ID}+1)+2^{M}λ+n_{ID})mod 2³¹.

In the above equation, λ is determined as 0 or 1 depending on the polarization information, N_{symb}^{slot}n_{s,f}^{μ} is a slot index, n_{ID} is an identification value for sequence identification, and 1 is an index of an orthogonal frequency division multiplexing (OFDM) symbol.

Alternatively, M may be 10 or 11.

Alternatively, the downlink signal may include: a demodulation reference signal (DMRS) for a physical broadcast channel (PBCH); a DMRS for a physical downlink control channel (PDCCH); a DMRS for a physical downlink shared channel (PDSCH); or a CSI-RS. The DMRSs and the CSI-RS may include the sequence initialized based on the parameter related to the polarization information.

Alternatively, the downlink signal may include a positioning reference signal (PRS) including the sequence initialized based on the parameter related to the polarization information.

Alternatively, the NTN may be configured to determine the polarization information on the downlink signal based on a cell identifier (ID) related to the NTN.

Alternatively, the method may further include transmitting a primary synchronization signal (PSS) and a secondary synchronization signal (SSS). The PSS and the SSS may include the sequence sequence-initialized based on the parameter related to the polarization information related to the cell ID.

In another aspect of the present disclosure, there is provided a method of receiving, by a user equipment (UE), a downlink signal based on polarization information from an NTN in a wireless communication system. The method may include: receiving the downlink signal from the NTN; and obtaining the polarization information based on a sequence included in the downlink signal. The UE may be configured to identify the polarization information on the downlink signal based on a sequence sequence-initialized based on a parameter related to the polarization information.

Alternatively, the downlink signal may be polarized based on one of linear polarization, RHCP, and LHCP.

In another aspect of the present disclosure, there is provided an NTN configured to transmit a downlink signal based on polarization information. The NTN may include: a radio frequency (RF) transceiver; and a processor connected to the RF transceiver. The processor may be configured to: generate a sequence related to the downlink signal; and control the RF transceiver to transmit the downlink signal based on the sequence. The sequence may be sequence-initialized based on a parameter related to the polarization information.

In another aspect of the present disclosure, there is provided a UE configured to receive a downlink signal based on polarization information from an NTN in a wireless communication system. The UE may include: an RF transceiver; and a processor connected to the RF transceiver. The processor may be configured to: control the RF transceiver to receive the downlink signal from the NTN; and identify the polarization information on the downlink signal based on a sequence sequence-initialized based on a parameter related to the polarization information.

In another aspect of the present disclosure, there is provided a chipset configured to transmit a downlink signal based on polarization information in a wireless communication system. The chipset may include: at least one processor; and at least one memory operably connected to the at least one processor and configured to, when executed, cause the at least one processor to perform operations. The operations may include: generating a sequence related to the downlink signal; and transmitting the downlink signal based on the sequence. The sequence may be sequence-initialized based on a parameter related to the polarization information.

In a further aspect of the present disclosure, there is provided a computer-readable storage medium including at least one computer program configured to perform operations to transmit a downlink signal based on polarization information in a wireless communication system. The at least one computer program may be configured to cause at least one processor to perform the operations to transmit the downlink signal. The at least one computer program may be stored on the computer-readable storage medium. The operations may include: generating a sequence related to the downlink signal; and transmitting the downlink signal based on the sequence. The sequence may be sequence-initialized based on a parameter related to the polarization information.

According to various embodiments, downlink signals may be identified and transmitted efficiently according to polarization information through sequence initialization based on the polarization information.

Effects to be achieved by embodiment(s) are not limited to what has been particularly described hereinabove and other effects not mentioned herein will be more clearly understood by persons skilled in the art to which embodiment(s) pertain from the following detailed description.

### BRIEF DESCRIPTION OF THE DRAWINGS

The accompanying drawings, which are included to provide a further understanding of the present disclosure, illustrate embodiments of the disclosure and together with the description serve to explain the principle of the present disclosure.

FIG. 1 illustrates the structure of an LTE system to which embodiment(s) are applicable.

FIG. 2 illustrates the structure of an NR system to which embodiment(s) are applicable.

FIG. 3 illustrates the structure of an NR radio frame to which embodiment(s) are applicable.

FIG. 4 illustrates the slot structure of an NR frame to which embodiment(s) are applicable.

FIG. 5 illustrates a procedure in which a base station transmits a downlink signal to a UE.

FIG. 6 illustrates a procedure in which a UE transmits an uplink signal to a base station.

FIG. 7 illustrates an example of time domain resource allocation for a PDSCH by a PDCCH and an example of time domain resource allocation for a PUSCH by a PDCCH.

FIG. 8 is a flowchart for explaining a method of generating and transmitting a downlink (DL) demodulation reference signal (DMRS).

FIG. 9 illustrates a non-terrestrial network (NTN).

FIG. 10 illustrates an overview and a scenario of an NTN.

FIG. 11 illustrates TA components of the NTN.

FIGS. 12 and 13 are diagrams for explaining polarization of an antenna.

FIG. 14 is a diagram for explaining a scenario related to polarization reuse.

FIG. 15 is a flowchart illustrating a method for a UE to perform a UL transmission operation based on embodiments.

FIG. 16 is a flowchart illustrating a method for a UE to perform a DL reception operation based on embodiments.

FIG. 17 is a flowchart illustrating a method for a BS to perform a UL reception operation based on embodiments.

FIG. 18 is a flowchart illustrating a method for a BS to perform a DL transmission operation based on embodiments.

FIGS. 19 and 20 are flowcharts illustrating methods of performing signaling between a BS and a UE based on embodiments.

FIG. 21 is a flowchart for explaining a method for an NTN to transmit a DL signal.

FIG. 22 is a flowchart for explaining a method for a UE to receive a DL signal.

FIG. 23 illustrates a communication system applied to the present disclosure.

FIG. 24 illustrates wireless devices applicable to the present disclosure.

FIG. 25 illustrates another example of a wireless device to which the present disclosure is applied.

### DETAILED DESCRIPTION

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2λ may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A, and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto

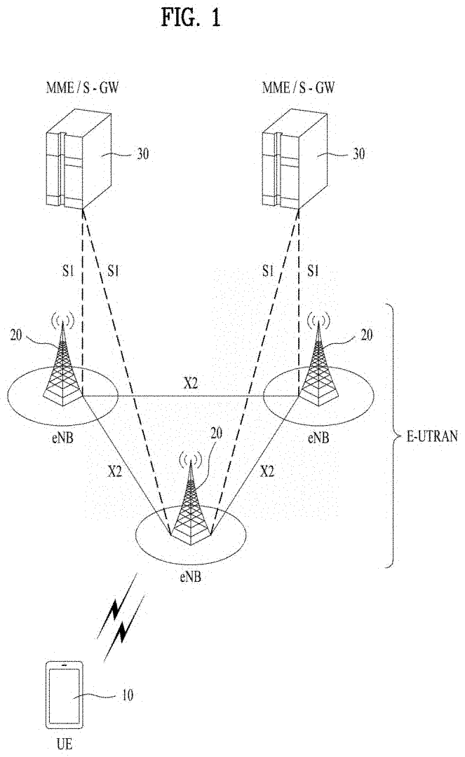

FIG. 1 illustrates the structure of an LTE system to which the present disclosure is applicable. This may also be called an evolved UMTS terrestrial radio access network (E-UTRAN) or LTE/LTE-A system.

Referring to FIG. 1, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

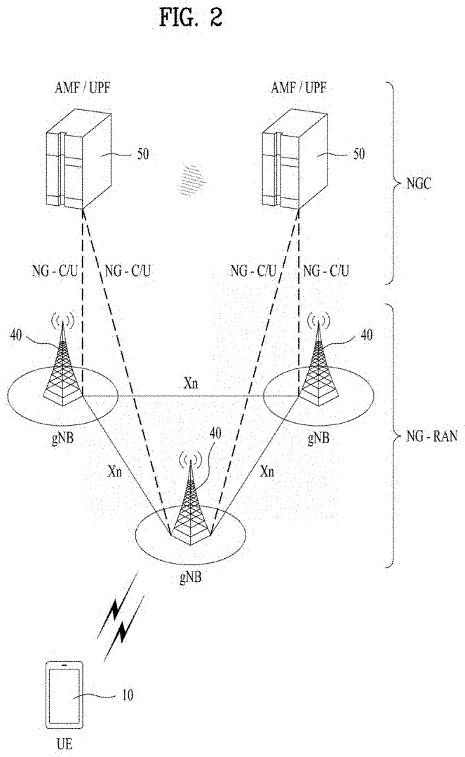

FIG. 2 illustrates the structure of a NR system to which the present disclosure is applicable.

Referring to FIG. 2, a next generation radio access network (NG-RAN) may include a next generation Node B (gNB) and/or an eNB, which provides user-plane and control-plane protocol termination to a UE. In FIG. 2, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

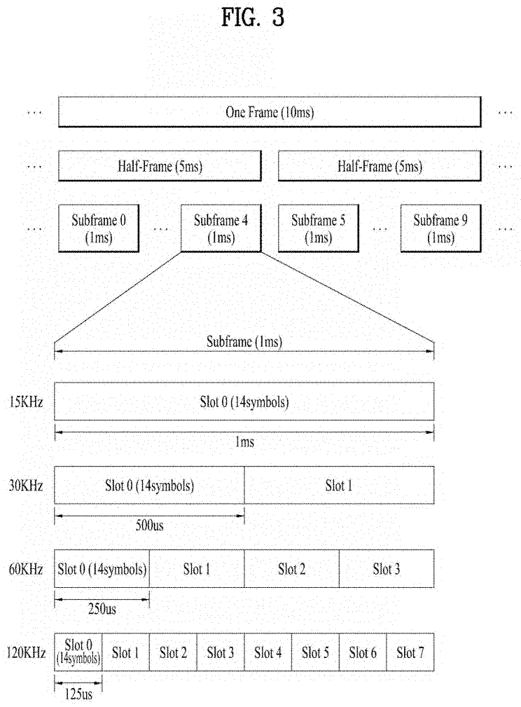

FIG. 3 illustrates the structure of a NR radio frame to which the present disclosure is applicable.

Referring to FIG. 3, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM(A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,μ}ₛₗₒₜ, and the number of slots per subframe N^{subframe,μ}ₛₗₒₜ according to an SCS configuration μ in the NCP case.

TABLE 1

| SCS (15*2u) | N^{slot}_{symb} | N^{frame, u}ₛₗₒₜ | N^{subframe, u}ₛₗₒₜ |
|---|---|---|---|
| 15 kHz (u = 0) | 14 | 10 | 1 |
| 30 kHz (u = 1) | 14 | 20 | 2 |
| 60 kHz (u = 2) | 14 | 40 | 4 |
| 120 kHz (u = 3) | 14 | 80 | 8 |
| 240 kHz (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 kHz (u = 2) | 12 | 40 | 4 |

In the NR system, different OFDM(A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency Range | Corresponding | Subcarrier |
|---|---|---|
| designation | frequency range | Spacing (SCS) |
| FR1 | 450 MHz-6000 MHz | 15, 30, 60 kHz |
| FR2 | 24250 MHz-52600 MHz | 60, 120, 240 kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHz (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

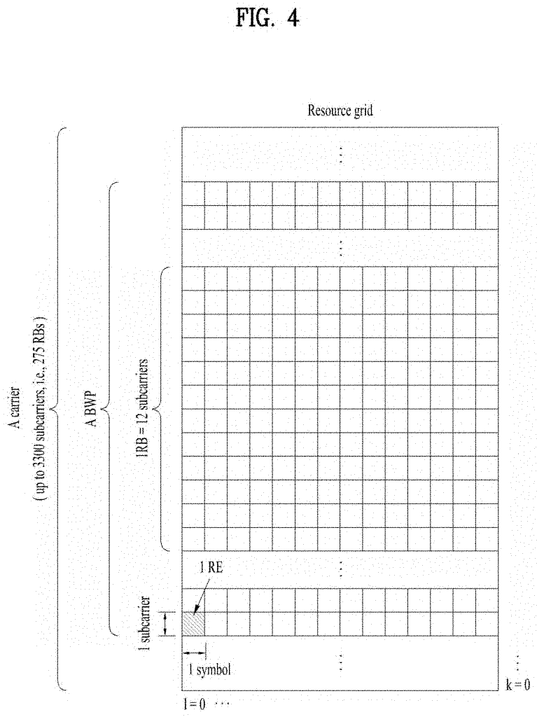

FIG. 4 illustrates the slot structure of a NR frame.

Referring to FIG. 4, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P)RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

Bandwidth Part (BWP)

In the NR system, up to 400 MHz may be supported per component carrier (CC). If a UE operating on a wideband CC always operates with the RF for the entire CCs turned on, the battery consumption of the UE may be increased. Alternatively, considering various use cases (e.g., eMBB, URLLC, mMTC, V2X, etc.) operating within one wideband CC, different numerologies (e.g., sub-carrier spacings) may be supported for different frequency bands within a specific CC. Alternatively, the capability for the maximum bandwidth may differ among the UEs. In consideration of this, the BS may instruct the UE to operate only in a partial bandwidth, not the entire bandwidth of the wideband CC. The partial bandwidth is defined as a bandwidth part (BWP) for simplicity. Here, the BWP may be composed of resource blocks (RBs) contiguous on the frequency axis, and may correspond to one numerology (e.g., sub-carrier spacing, CP length, slot/mini-slot duration).

The BS may configure multiple BWPs in one CC configured for the UE. For example, a BWP occupying a relatively small frequency region may be configured in a PDCCH monitoring slot, and a PDSCH indicated by the PDCCH in a larger BWP may be scheduled. Alternatively, when UEs are concentrated in a specific BWP, some of the UEs may be configured in another BWP for load balancing. Alternatively, a spectrum in the middle of the entire bandwidth may be punctured and two BWPs on both sides may be configured in the same slot in consideration of frequency-domain inter-cell interference cancellation between neighbor cells. That is, the BS may configure at least one DL/UL BWP for the UE associated with the wideband CC and activate at least one DL/UL BWP among the configured DL/UL BWP(s) at a specific time (through L1 signaling, MAC CE or RRC signalling, etc.). The BS may instruct the UE to switch to another configured DL/UL BWP (through L1 signaling, MAC CE or RRC signalling, etc.). Alternatively, when a timer expires, the UE may switch to a predetermined DL/UL BWP. The activated DL/UL BWP is defined as an active DL/UL BWP. The UE may fail to receive DL/UL BWP configuration during an initial access procedure or before an RRC connection is set up. A DL/UL BWP assumed by the UE in this situation is defined as an initial active DL/UL BWP.

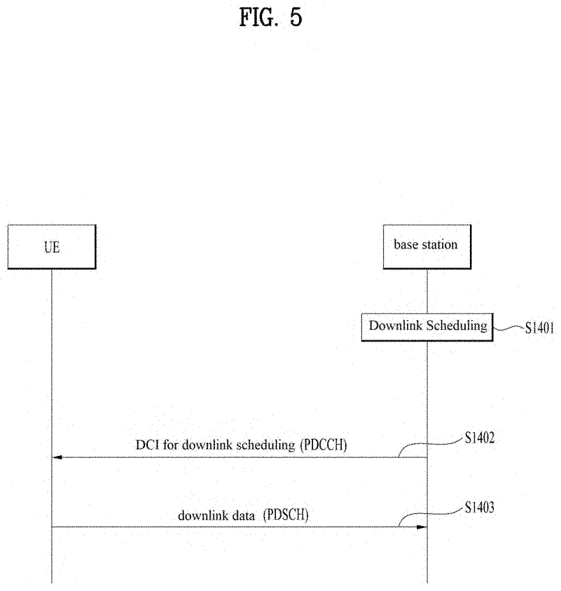

FIG. 5 illustrates a procedure in which a base station transmits a downlink (DL) signal to a UE

Referring to FIG. 5, the BS schedules DL transmission in relation to, for example, frequency/time resources, a transport layer, a DL precoder, and an MCS (S1401). In particular, the BS may determine a beam for PDSCH transmission to the UE through the above-described operations.

The UE receives downlink control information (DCI) for DL scheduling (i.e., including scheduling information about the PDSCH) from the BS on the PDCCH (S1402).

DCI format 1_0 or 1_1 may be used for DL scheduling. In particular, DCI format 1_1 includes the following information: an identifier for DCI formats, a bandwidth part indicator, frequency domain resource assignment, time domain resource assignment, a PRB bundling size indicator, a rate matching indicator, a ZP CSI-RS trigger, antenna port(s), transmission configuration indication (TCI), an SRS request, and a demodulation reference signal (DMRS) sequence initialization.

In particular, according to each state indicated in the antenna port(s) field, the number of DMRS ports may be scheduled, and single-user (SU)/multi-user (MU) transmission may also be scheduled.

In addition, the TCI field is configured in 3 bits, and the QCL for the DMRS is dynamically indicated by indicating a maximum of 8 TCI states according to the value of the TCI field.

The UE receives DL data from the BS on the PDSCH (S1403).

When the UE detects a PDCCH including DCI format 1_0 or 1_1, it decodes the PDSCH according to an indication by the DCI. Here, when the UE receives a PDSCH scheduled by DCI format 1, a DMRS configuration type may be configured for the UE by a higher layer parameter ‘dmrs-Type’, and the DMRS type is used to receive the PDSCH. In addition, the maximum number of front-loaded DMRS symbols for the PDSCH may be configured for the UE by the higher layer parameter ‘maxLength’.

In the case of DMRS configuration type 1, when a single codeword is scheduled for the UE and an antenna port mapped to an index of {2, 9, 10, 11, or 30} is specified, or when two codewords are scheduled for the UE, the UE assumes that any of the remaining orthogonal antenna ports is not associated with PDSCH transmission to another UE.

Alternatively, in the case of DMRS configuration type 2, when a single codeword is scheduled for the UE and an antenna port mapped to an index of {2, 10, or 23} is specified, or when two codewords are scheduled for the UE, the UE assumes that any of the remaining orthogonal antenna ports is not associated with PDSCH transmission to another UE.

When the UE receives the PDSCH, it may assume that the precoding granularity P′ is a consecutive resource block in the frequency domain. Here, P′ may correspond to one of {2, 4, wideband}.

When P′ is determined as wideband, the UE does not expect scheduling with non-contiguous PRBs, and may assume that the same precoding is applied to the allocated resources.

On the other hand, when P′ is determined as any one of {2, 4}, a precoding resource block group (PRG) is divided into P′ contiguous PRBs. The number of actually contiguous PRBs in each PRG may be greater than or equal to 1. The UE may assume that the same precoding is applied to contiguous DL PRBs in the PRG.

In order to determine a modulation order, a target code rate, and a transport block size in the PDSCH, the UE first reads the 5-bit MCD field in the DCI, and determines the modulation order and the target code rate. Then, it reads the redundancy version field in the DCI, and determines the redundancy version. Then, the UE determines the transport block size based on the number of layers and the total number of allocated PRBs before rate matching.

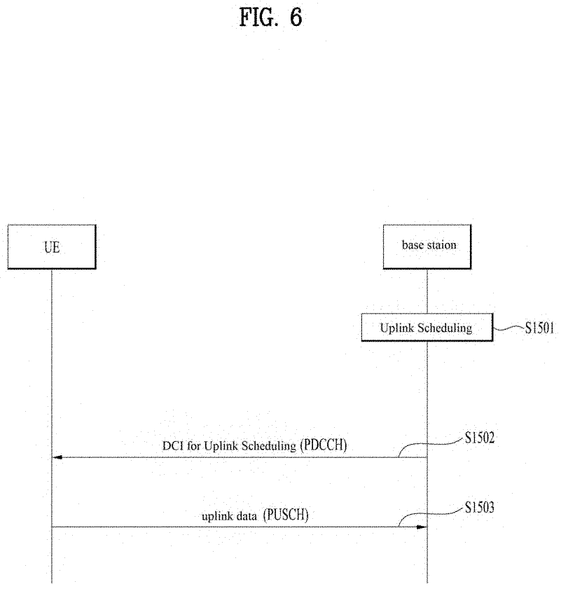

FIG. 6 illustrates a procedure in which a UE transmits an uplink (UL) signal to a BS.

Referring to FIG. 6, the BS schedules UL transmission in relation to, for example, frequency/time resources, a transport layer, a UL precoder, and an MCS (S1501). In particular, the BS may determine, through the above-described operations, a beam for PUSCH transmission of the UE.

The UE receives DCI for UL scheduling (including scheduling information about the PUSCH) from the BS on the PDCCH (S1502).

DCI format 0_0 or 0_1 may be used for UL scheduling. In particular, DCI format 0_1 includes the following information: an identifier for DCI formats, a UL/supplementary UL (SUL), a bandwidth part indicator, frequency domain resource assignment, time domain resource assignment, a frequency hopping flag, a modulation and coding scheme (MCS), an SRS resource indicator (SRI), precoding information and number of layers, antenna port(s), an SRS request, DMRS sequence initialization, and UL shared channel (UL-SCH) indicator.

In particular, SRS resources configured in an SRS resource set associated with the higher layer parameter ‘usage’ may be indicated by the SRS resource indicator field. In addition, ‘spatialRelationInfo’ may be configured for each SRS resource, and the value thereof may be one of {CRI, SSB, SRI}.

The UE transmits UL data to the BS on PUSCH (S1503).

When the UE detects a PDCCH including DCI format 0_0 or 0_1, it transmits the PUSCH according to an indication by the DCI.

For PUSCH transmission, two transmission schemes are supported: codebook-based transmission and non-codebook-based transmission:

i) When the higher layer parameter ‘txConfig’ is set to ‘codebook’, the UE is configured for codebook-based transmission. On the other hand, when the higher layer parameter ‘txConfig’ is set to ‘nonCodebook’, the UE is configured for non-codebook based transmission. When the higher layer parameter ‘txConfig’ is not configured, the UE does not expect scheduling by DCI format 0_1. When the PUSCH is scheduled according to DCI format 0_0, PUSCH transmission is based on a single antenna port.

In the case of codebook-based transmission, the PUSCH may be scheduled by DCI format 0_0 or DCI format 0_1, or scheduled semi-statically. When the PUSCH is scheduled by DCI format 0_1, the UE determines the PUSCH transmission precoder based on the SRI, transmit precoding matrix indicator (TPMI) and transmission rank from the DCI, as given by the SRS resource indicator field and the precoding information and number of layers field. The TPMI is used to indicate a precoder to be applied across antenna ports, and corresponds to an SRS resource selected by the SRI when multiple SRS resources are configured. Alternatively, when a single SRS resource is configured, the TPMI is used to indicate a precoder to be applied across antenna ports, and corresponds to the single SRS resource. A transmission precoder is selected from the UL codebook having the same number of antenna ports as the higher layer parameter ‘nrofSRS-Ports’. When the higher layer in which the UE is set to ‘codebook’ is configured with the parameter ‘txConfig’, at least one SRS resource is configured for the UE. The SRI indicated in slot n is associated with the most recent transmission of the SRS resource identified by the SRI, where the SRS resource precedes the PDCCH carrying the SRI (i.e., slot n).

ii) In the case of non-codebook-based transmission, the PUSCH may be scheduled by DCI format 0_0 or DCI format 0_1, or scheduled semi-statically. When multiple SRS resources are configured, the UE may determine the PUSCH precoder and transmission rank based on the wideband SRI. Here, the SRI is given by the SRS resource indicator in the DCI or by the higher layer parameter ‘srs-ResourceIndicator’. The UE may use one or multiple SRS resources for SRS transmission. Here, the number of SRS resources may be configured for simultaneous transmission within the same RB based on UE capability. Only one SRS port is configured for each SRS resource. Only one SRS resource may be configured by the higher layer parameter ‘usage’ set to ‘nonCodebook’. The maximum number of SRS resources that may be configured for non-codebook-based UL transmission is 4. The SRI indicated in slot n is associated with the most recent transmission of the SRS resource identified by the SRI, where the SRS transmission precedes the PDCCH carrying the SRI (i.e., slot n).

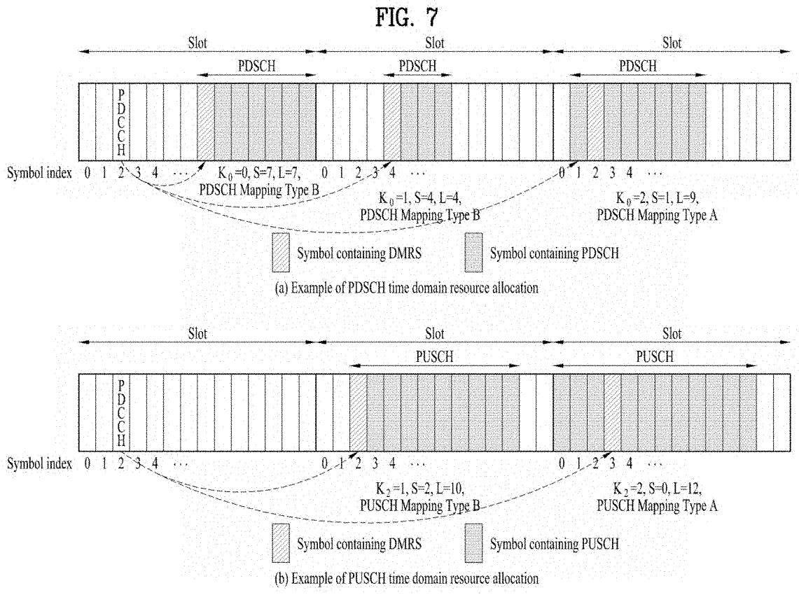

FIG. 7 illustrates an example of time domain resource allocation for a PDSCH by a PDCCH and an example of time domain resource allocation for a PUSCH by a PDCCH.

DCI carried by the PDCCH in order to schedule a PDSCH or a PUSCH includes a (time domain resource assignment, TDRA) field. The TDRA field provides a value m for a row index m+1 to an allocation table for the PDSCH or the PUSCH. Predefined default PDSCH time domain allocation is applied as the allocation table for the PDSCH, or a PDSCH TDRA table that the BS configures through RRC signaledpdsch-TimeDomainAllocationList is applied as the allocation table for the PDSCH. Predefined default PUSCH time domain allocation is applied as the allocation table for the PDSCH, or a PUSCH TDRA table that the BS configures through RRC signaled pusch-TimeDomainAllocationList is applied as the allocation table for the PUSCH. The PDSCH TDRA table to be applied and/or the PUSCH TDRA table to be applied may be determined according a fixed/predefined rule (e.g., refer to 3GPP TS 38.214)

In PDSCH time domain resource configurations, each indexed row defines a DL assignment-to-PDSCH slot offset K₀, a start and length indicator value SLIV (or directly, a start position (e.g., start symbol index S) and an allocation length (e.g., the number of symbols, L) of the PDSCH in a slot), and a PDSCH mapping type. In PUSCH time domain resource configurations, each indexed row defines a UL grant-to-PUSCH slot offset K₂, a start position (e.g., start symbol index S) and an allocation length (e.g., the number of symbols, L) of the PUSCH in a slot, and a PUSCH mapping type. K₀ for the PDSCH and K₂ for the PUSCH indicate the difference between the slot with the PDCCH and the slot with the PDSCH or PUSCH corresponding to the PDCCH. SLIV denotes a joint indicator of the start symbol S relative to the start of the slot with the PDSCH or PUSCH and the number of consecutive symbols, L, counting from the symbol S. The PDSCH/PUSCH mapping type includes two mapping types: one is mapping Type A and the other is mapping Type B. In PDSCH/PUSCH mapping Type A, a demodulation reference signal (DMRS) is located in the third symbol (symbol #2) or fourth symbol (symbol #3) in a slot according to RRC signaling. In PDSCH/PUSCH mapping Type B, the DMRS is located in the first symbol allocated for the PDSCH/PUSCH.

The scheduling DCI includes an FDRA field that provides assignment information about RBs used for the PDSCH or the PUSCH. For example, the FDRA field provides information about a cell for PDSCH or PUSCH transmission, information about a BWP for PDSCH or PUSCH transmission, and/or information about RBs for PDSCH or PUSCH transmission to the UE.

* Resource Allocation by RRC

As mentioned above, there are two types of transmission without a dynamic grant: configured grant Type 1 and configured grant Type 2. In configured grant Type 1, a UL grant is provided by RRC signaling and stored as a configured UL grant. In configured grant Type 2, the UL grant is provided by the PDCCH and stored or cleared as the configured UL grant based on L1 signaling indicating configured UL grant activation or deactivation. Type 1 and Type 2 may be configured by RRC signaling per serving cell and per BWP. Multiple configurations may be simultaneously activated on different serving cells.

When configured grant Type 1 is configured, the UE may be provided with the following parameters through RRC signaling:
cs-RNTI corresponding to a CS-RNTI for retransmission;
periodicity corresponding to a periodicity of configured grant Type 1;
timeDomainOffset indicating an offset of a resource with respect to system frame number (SFN)=0 in the time domain;
timeDomainAllocation value m that provides a row index m+1 pointing to the allocation table, indicating a combination of the start symbol S, the length L, and the PUSCH mapping type;
frequencyDomainAllocation that provides frequency domain resource allocation; and
mcsAndTBS that provides IMCS indicating a modulation order, a target code rate, and a transport block size.

Upon configuration of configured grant Type 1 for a serving cell by RRC, the UE stores the UL grant provided by RRC as a configured UL grant for an indicated serving cell and initializes or re-initializes the configured UL grant to start in a symbol according to timeDomainOffset and S (derived from SLIV) and to recur with periodicity. After the UL grant is configured for configured grant Type 1, the UE may consider that the UL grant recurs in association with each symbol satisfying: [(SFN*numberOfSlotsPerFrame (numberOfSymbolsPerSlot)+(slot number in the frame*numberOfSymbolsPerSlot)+symbol number in the slot]=(timeDomainOffset*numberOfSymbolsPerSlot+S+N*periodicity) modulo (1024*numberOfSlotsPerFrame*numberOfSymbolsPerSlot), for all N>=0, where numberOfSlotsPerFrame and numberOfSymbolsPerSlot indicate the number of consecutive slots per frame and consecutive OFDM symbols per slot.

For configured grant Type 2, the UE may be provided with the following parameters by the BS through RRC signaling:
cs-RNTI corresponding to a CS-RNTI for activation, deactivation, and retransmission; and
periodicity that provides a periodicity of configured grant Type 2.

An actual UL grant is provided to the UE by the PDCCH (addressed to the CS-RNTI). After the UL grant is configured for configured grant Type 2, the UE may consider that the UL grant recurs in association with each symbol satisfying: [(SFN*numberOfSlotsPerFrame*numberOfSymbolsPerSlot)+(slot number in the frame*numberOfSymbolsPerSlot)+symbol number in the slot]=[(SFN_{start time}*numberOfSlotsPerFrame*numberOfSymbolsPerSlot+slot_{start time}*numberOfSymbolsPerSlot+symbolstar time)+N*periodicity] modulo (1024*numberOfSlotsPerFrame*numberOfSymbolsPerSlot), for all N>=0, where SFN_{start time}, slot_{start time}, and symbol_{start time} represent an SFN, a slot, and a symbol, respectively, of the first transmission opportunity of the PUSCH after the configured grant is (re-)initialized, and numberOfSlotsPerFrame and numberOfSymbolsPerSlot indicate the number of consecutive slots per frame and consecutive OFDM symbols per slot, respectively.

On DL, the UE may be configured with SPS per serving cell and per BWP by RRC signaling from the BS. For DL SPS, DL assignment is provided to the UE by the PDCCH and stored or cleared based on L1 signaling indicating SPS activation or deactivation. When SPS is configured, the UE may be provided with the following parameters by the BS through RRC signaling:
cs-RNTI corresponding to a CS-RNTI for activation, deactivation, and retransmission;
nrofHARQ-Processes that provides the number of HARQ processes for SPS; and
periodicity that provides a periodicity of configured DL assignment for SPS.

After DL assignment is configured for SPS, the UE may consider sequentially that N-th DL assignment occurs in a slot satisfying: (numberOfSlotsPerFrame*SFN+slot number in the frame)=[(numberOfSlotsPerFrame*SFN_{start time}+slot_{start time})+N*periodicity*numberOfSlotsPerFrame/10] modulo (1024*numberOfSlotsPerFrame), where SFN_{start time} and slot_{start time} represent an SFN and a slot, respectively, of first transmission of the PDSCH after configured DL assignment is (re-)initialized, and numberOfSlotsPerFrame and numberOfSymbolsPerSlot indicate the number of consecutive slots per frame and consecutive OFDM symbols per slot, respectively.

If the CRC of a corresponding DCI format is scrambled with the CS-RNTI provided by the RRC parameter cs-RNTI, and a new data indicator field for an enabled transport block is set to 0, the UE validates, for scheduling activation or scheduling release, a DL SPS assignment PDCCH or a configured UL grant Type 2 PDCCH. Validation of the DCI format is achieved if all fields for the DCI format are set. An example of special fields for DL SPS and UL grant Type 2 scheduling activation PDCCH validation, and an example of special fields for DL SPS and UL grant Type 2 scheduling release PDCCH validation.

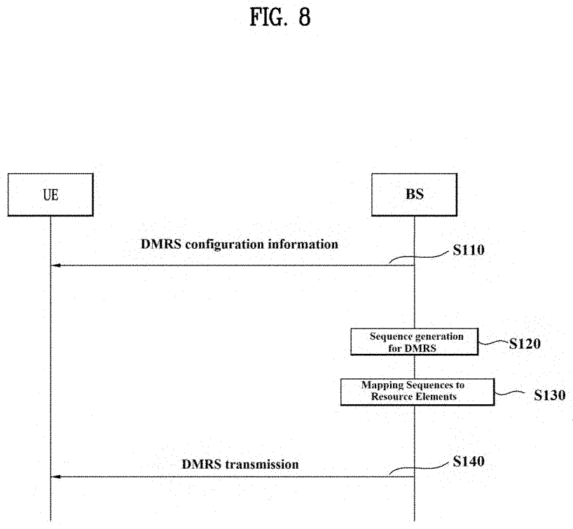

FIG. 8 is a flowchart for explaining a method of generating and transmitting a DL DMRS.
The BS may transmit DMRS configuration information to the UE (S110).

The DMRS configuration information may refer to a DMRS-DownlinkConfig IE. The DMRS-DownlinkConfig IE may include the following parameters: dmrs-Type, dmrs-AdditionalPosition, maxLength, and phaseTrackingRS. The parameter dmrs-Type is to select a DMRS type to be used for DL.

In NR, a DMRS may be divided into two configuration types: (1) DMRS configuration type 1 and (2) DMRS configuration type 2. DMRS configuration type 1 has a higher RS density in the frequency domain, and DMRS configuration type 2 has more DMRS antenna ports. The parameter dmrs-AdditionalPosition indicates the position of an additional DL DMRS. For the DMRS, the first position of a front-loaded DMRS may be determined depending on PDSCH mapping types (type A or type B), and an additional DMRS may be configured to support a high-speed UE. The front-loaded DMRS may occupy one or two consecutive OFDM symbols and be indicated by RRC signaling and DCI. The parameter maxLength indicates the maximum number of OFDM symbols for the DL front-loaded DMRS. The parameter phaseTrackingRS is to configure a DL phase tracking reference signal (PTRS).
The BS may generate a sequence used for the DMRS (S120).

The sequence for the DMRS may be generated according to Equation 1 below.

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) \qquad [ Equation 1 ]$$

In Equation 1, c(i) is a pseudo-random sequence defined in Clause 5.2.1 of 3GPP TS 38.211. That is, c(i) may be a Gold sequence of length-31 based on two m-sequences. The pseudo-random sequence generator may be initialized by Equation 2 below.

cᵢₙᵢₜ=(2¹⁷(N_{symb}^{slot}n_{s,f}^{μ}+l+1)(2N_{ID}ⁿ^{_{SCID}}+1)+2N_{ID}ⁿ^{_{SCID}}+n_{SCID})mod 2³¹ [Equation 2]

In Equation 2, l denotes an OFDM symbol number in a slot, and n_{s,f}^{μ} denotes a slot number in a frame.

When a PDSCH is scheduled by a PDCCH based on DCI format 1_1 with a CRC scrambled by a C-RNTI, MCS-C-RNTI or CS-RNTI, N_{ID}⁰ and N_{ID}¹∈{0, 1, . . . , 65535} may be given by higher layer parameters scramblingID0 and scramblingID1 in the DMRS-DownlinkConfig IE, respectively.
When a PDSCH is scheduled by a PDCCH based on DCI format 1_0 with a CRC scrambled by a C-RNTI, MCS-C-RNTI, or CS-RNTI, N_{ID}⁰∈{0, 1, . . . , 65535} may be given by the higher layer parameter scramblingID0 in the DMRS-DownlinkConfig IE.
When the above parameters are not given, and when DCI format 1_1 is used, N_{ID}ⁿ^{_{SCID}}=N_{ID}^{cell} and quantity n_{SCID}∈{0, 1} may be given by a DMRS Sequence Initialization field in DCI related to PDSCH transmission.
The BS may map the generated sequence to an RE (S130). Here, the RE may include at least one of a time, frequency, antenna port, or code.
The BS may transmit the DMRS to the UE on the RE (S140). The UE may receive a PDSCH based on the received DMRS.

Non-Terrestrial Networks Reference

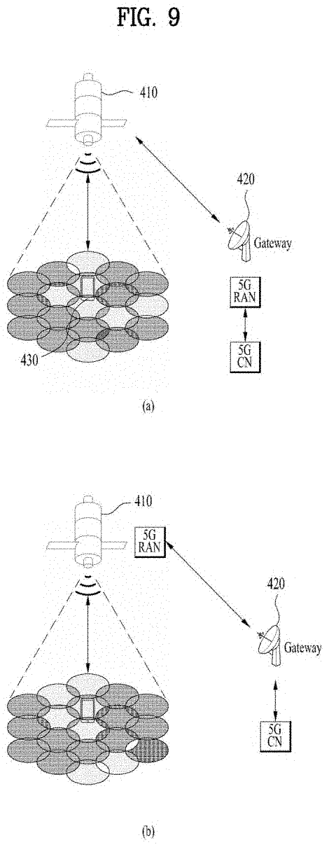

FIG. 9 illustrates a non-terrestrial network (NTN).

A non-terrestrial network (NTN) refers to a wireless network configured using satellites (e.g., geostationary earth orbit satellites (GEO)/low-earth orbit satellites (LEO)). Based on the NTN, coverage may be extended and a highly reliable network service may be provided. For example, the NTN may be configured alone, or may be combined with a conventional terrestrial network to configure a wireless communication system. For example, in the NTN network, i) a link between a satellite and a UE, ii) a link between satellites, iii) a link between a satellite and a gateway, and the like may be configured.

The following terms may be used to describe the configuration of a wireless communication system employing satellites.
Satellite: a space-borne vehicle embarking a bent pipe payload or a regenerative payload telecommunication transmitter, placed into Low-Earth Orbit (LEO) typically at an altitude between 500 km to 2000 km, Medium-Earth Orbit (MEO) typically at an altitude between 8000 to 20000 lm, or Geostationary satellite Earth Orbit (GEO) at 35 786 km altitude.
Satellite network: Network, or segments of network, using a space-borne vehicle to embark a transmission equipment relay node or base station.
Satellite RAT: a RAT defined to support at least one satellite.
5G Satellite RAT: a Satellite RAT defined as part of the New Radio.
5G satellite access network: 5G access network using at least one satellite.
Terrestrial: located at the surface of Earth.
Terrestrial network: Network, or segments of a network located at the surface of the Earth.

Use cases that may be provided by a communication system employing a satellite connection may be divided into three categories. The “Service Continuity” category may be used to provide network connectivity in geographic areas where 5G services cannot be accessed through the wireless coverage of terrestrial networks. For example, a satellite connection may be used for a UE associated with a pedestrian user or a UE on a moving land-based platform (e.g., car, coach, truck, train), air platform (e.g., commercial or private jet) or marine platform (e.g., marine vessel). In the “Service Ubiquity” category, when terrestrial networks are unavailable (due to, for example, disaster, destruction, economic situations, etc.), satellite connections may be used for IOT/public safety-related emergency networks/home access, etc. The “Service Scalability” category includes services using wide coverage of satellite networks.

For example, a 5G satellite access network may be connected to a 5G core Network. In this case, the satellite may be a bent pipe satellite or a regenerative satellite. The NR radio protocols may be used between the UE and the satellite. Also, F1 interface may be used between the satellite and the gNB.

As described above, a non-terrestrial network (NTN) refers to a wireless network configured using a device that is not fixed on the ground, such as satellite. A representative example is a satellite network. Based on the NTN, coverage may be extended and a highly reliable network service may be provided. For example, the NTN may be configured alone, or may be combined with an existing terrestrial network to configure a wireless communication system.

Use cases that may be provided by a communication system employing an NTN may be divided into three categories. The “Service Continuity” category may be used to provide network connectivity in geographic areas where 5G services cannot be accessed through the wireless coverage of terrestrial networks. For example, a satellite connection may be used for a UE associated with a pedestrian user or a UE on a moving land-based platform (e.g., car, coach, truck, train), air platform (e.g., commercial or private jet) or marine platform (e.g., marine vessel). In the “Service Ubiquity” category, when terrestrial networks are unavailable (due to, for example, disaster, destruction, economic situations, etc.), satellite connections may be used for IOT/public safety-related emergency networks/home access, etc. The “Service Scalability” category includes services using wide coverage of satellite networks.

Referring to FIG. 9, the NTN includes one or more satellites 410, one or more NTN gateways 420 capable of communicating with the satellites, and one or more UEs (/BSs) 430 capable of receiving mobile satellite services from the satellites. For simplicity, the description is focused on the example of the NTN including satellites, but is not intended to limit the scope of the present disclosure. Accordingly, the NTN may include not only the satellites, but also aerial vehicles (Unmanned Aircraft Systems (UAS) encompassing tethered UAS (TUA), Lighter than Air UAS (LTA), Heavier than Air UAS (HTA), all operating in altitudes typically between 8 and 50 km including High Altitude Platforms (HAPs)).

The satellite 410 is a space-borne vehicle equipped with a bent pipe payload or a regenerative payload telecommunication transmitter and may be located in a low earth orbit (LEO), a medium earth orbit (MEO), or a geostationary earth orbit (GEO). The NTN gateway 420 is an earth station or gateway existing on the surface of the earth, and provides sufficient RF power/sensitivity to access the satellite. The NTN gateway corresponds to a transport network layer (TNL) node.

The NTN may have i) a link between a satellite and a UE, ii) a link between satellites, iii) a link between a satellite and an NTN gateway. A service link refers to a radio link between a satellite and a UE. Inter-satellite links (ISLs) between satellites may be present when there are multiple satellites. A feeder link refers to a radio link between an NTN gateway and a satellite (or UAS platform). The gateway may be connected to a data network and may communicate with a satellite through the feeder link. The UE may communicate via the satellite and service link.

As NTN operation scenarios, two scenarios which are based on transparent payload and regenerative payload, respectively may be considered. FIG. 9-(a) shows an example of a scenario based on a transparent payload. In the scenario based on the transparent payload, the signal repeated by the payload is not changed. The satellites 410 repeat the NR-Uu radio interface from the feeder link to the service link (or vice versa), and the satellite radio interface (SRI) on the feeder link is NR-Uu. The NTN gateway 420 supports all functions necessary to transfer the signal of the NR-Uu interface. Also, different transparent satellites may be connected to the same gNB on the ground. FIG. 9-(b) shows an example of a scenario based on a regenerative payload. In the scenario based on the regenerative payload, the satellite 410 may perform some or all of the functions of a conventional BS (e.g., gNB), and may thus perform some or all of frequency conversion/demodulation/decoding/modulation. The service link between the UE and a satellite is established using the NR-Uu radio interface, and the feeder link between the NTN gateway and a satellite is established using the satellite radio interface (SRI). The SRI corresponds to a transport link between the NTN gateway and the satellite.

The UE 430 may be connected to 5GCN through an NTN-based NG-RAN and a conventional cellular NG-RAN simultaneously. Alternatively, the UE may be connected to the 5GCN via two or more NTNs (e.g., LEO NTN and GEO NTN, etc.) simultaneously.

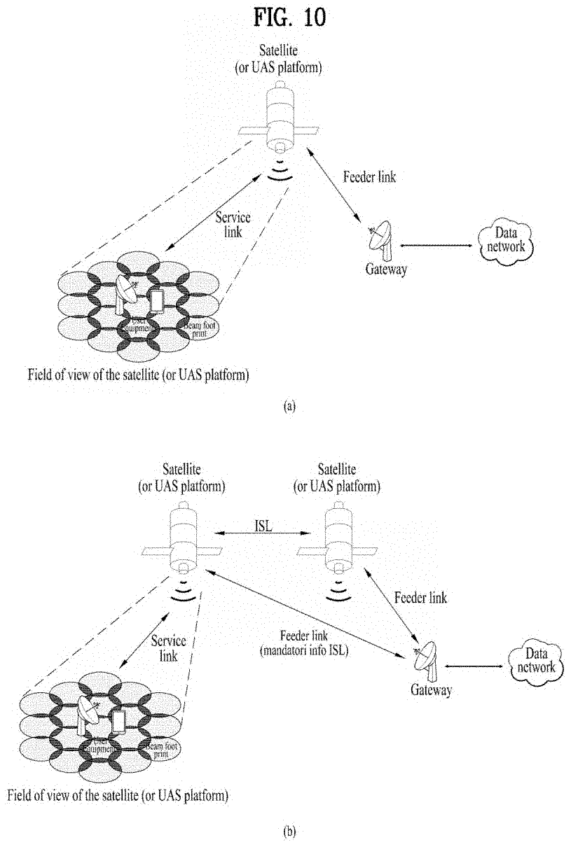

FIG. 10 illustrates an overview and a scenario of an NTN.

NTN refers to a network or network segment in which a satellite (or UAS platform) uses RF resources. Typical scenarios of the NTN providing access to a UE include an NTN scenario based on a transparent payload as shown in FIG. 10-(a) and an NTN scenario based on a regenerative payload as shown in FIG. 10-(b).

NTN typically features the following elements,
One or several sat-gateways that connect the Non-Terrestrial Network to a public data network
A GEO satellite is fed by one or several sat-gateways which are deployed across the satellite targeted coverage (e.g. regional or even continental coverage). We assume that UE in a cell are served by only one sat-gateway.

A Non-GEO satellite served successively by one or several sat-gateways at a time. The system ensures service and feeder link continuity between the successive serving sat-gateways with sufficient time duration to proceed with mobility anchoring and hand-over.
A feeder link or radio link between a sat-gateway and the satellite (or UAS platform)
A service link or radio link between the user equipment and the satellite (or UAS platform).
A satellite (or UAS platform) which may implement either a transparent or a regenerative (with on board processing) payload. The satellite (or UAS platform) generate beams typically generate several beams over a given service area bounded by its field of view. The footprints of the beams are typically of elliptic shape. The field of view of a satellites (or UAS platforms) depends on the on board antenna diagram and min elevation angle.
A transparent payload: Radio Frequency filtering, Frequency conversion and amplification. Hence, the waveform signal repeated by the payload is un-changed;
A regenerative payload: Radio Frequency filtering, Frequency conversion and amplification as well as demodulation/decoding, switch and/or routing, coding/modulation. This is effectively equivalent to having all or part of base station functions (e.g. gNB) on board the satellite (or UAS platform).
Inter-satellite links (ISL) optionally in case of a constellation of satellites. This will require regenerative payloads on board the satellites. ISL may operate in RF frequency or optical bands.
User Equipment is served by the satellite (or UAS platform) within the targeted service area.

Table 5 below defines various types of satellites (or UAS platforms).

TABLE 5

| | | | | Typical beam | |
|---|---|---|---|---|---|
| Platforms | Altitude range | | Orbit | footprint size | |
| Low-Earth Orbit | 300-1500 | km | Circular around the | 100-1000 | km |
| (LEO) satellite | | | earth | | |
| Medium-Eart Orbit | 7000-25000 | km | | 100-1000 | km |
| (MEO) satellite | | | | | |
| Geostationary | 35 786 | km | notional station keeping | 200-3500 | km |
| Earth Orbit (GEO) | | | position fixed in terms | | |
| satellite | | | of elevation/azimuth with | | |
| UAS platfor | 8-50 km (20 km | | respect to a given earth | 5-200 | km |
| (including HAPS) | for HAPS) | | point | | |
| High Elliptical | 400-50000 | km | Elliptical around the | 200-3500 | km |
| Orbit (HEO) | | | earth | | |
| satellite | | | | | |

Typically, GEO satellite and UAS are used to provide continental, regional or local service. A constellation of LEO and MEO is used to provide services in both Northern and Southern hemispheres. In some case, the constellation can even provide global coverage including polar regions. For the later, this requires appropriate orbit inclination, sufficient beams generated and inter-satellite links. HEO satellite systems are not considered in this document.

An NTN that provides access to a terminal in six reference scenarios described below can be considered.

Circular orbiting and notional station keeping platforms.

Highest RTD constraint

Highest Doppler constraint

A transparent and a regenerative payload

One ISL case and one without ISL. Regenerative payload is mandatory in the case of inter-satellite links.

Fixed or steerable beams resulting respectively in moving or fixed beam foot print on the ground

Six scenarios are considered as depicted in Table 6 and are detailed in Table 7.

TABLE 6

| | Transparent | Regenerative |
|---|---|---|
| | satellite | satellite |
| GEO based non-terrestrial | Scenario A | Scenario B |
| access network | | |
| LEO based non-terrestrial | Scenario C1 | Scenario D1 |
| access network: steerable beams | | |
| LEO based non-terrestrial | Scenario C2 | Scenario D2 |
| access network: the beams move | | |
| with the satellite | | |

TABLE 7

| Scenarios | GEO based non-terrestrial access | LEO based non-terrestrial |
|---|---|---|
| | network (Scenario A and B) | access network (Scenario C |
| | | & D) |
| Orbit type | notional station keeping position | circular orbiting around the |
| | fixed in terms of elevation/azimuth | earth |
| | with respect to a given earth point | |
| Altitude | 35,786 km | 600 km |
| | | 1,200 km |
| Spectrum (service link) | <6 GHz (e.g. 2 GHz) | |
| | >6 GHz (e.g. DL 20 GHz, UL 30 GHz) | |
| Max channel bandwidth | 30 MHz for band < 6 GHz | |
| capability (service link) | 1 GHz for band > 6 GHz | |
| Payload | Scenario A: Transparent | Scenario C: Transparent |
| | (including radio frequency | (including radio frequency |
| | function only) | function only) |
| | Scenario B: regenerative | Scenario D: Regenerative |
| | (including all or part of RAN | (including all or part of RAN |
| | functions) | functions) |
| Inter-Satellite link | No | Scenario C: No |
| | | Scenario D: Yes/No (Both |
| | | cases are possible.) |
| Earth-fixed beams | Yes | Scenario C1: Yes (steerable |
| | | beams), see note 1 |
| | | Scenario C2: No (the beams |
| | | move with the satellite) |
| | | Scenario D 1: Yes (steerable |
| | | beams), see note 1 |
| | | Scenario D 2: No (the beams |
| | | move with the satellite) |
| Max beam foot print | 3500 km (Note 5) | 1000 km |
| size (edge to edge) | | |
| regardless of the | | |
| elevation angle | | |
| Min Elevation angle for | 10° for service link and 10° | 10° for service link and 10° |
| both sat-gateway and | for feeder link | for feeder link |
| user equipment | | |
| Max distance between | 40,581 km | 1,932 km (600 km altitude) |
| satellite and user | | 3,131 km (1,200 km altitude) |
| equipment at min | | |
| elevation angle | | |
| Max Round Trip Delay | Scenario A: 541.46 ms (service | Scenario C: (transparent payload: |
| (propagation delay | and feeder links) | service and feeder links) |
| only) | Scenario B: 270.73 ms (service | 25.77 ms (600 km) |
| | link only) | 41.77 ms (1200 km) |
| | | Scenario D: (regenerative |
| | | payload: service link only) |
| | | 12.89 ms (600 km) |
| | | 20.89 ms (1200 km) |
| Max differential delay | 10.3 ms | 3.12 ms and 3.18 ms for |
| within a cell (Note 6) | | respectively 600 km and 1200 km |
| Max Doppler shift | 0.93 ppm | 24 ppm (600 km) |
| (earth fixed user | | 21 ppm (1200 km) |
| equipment) | | |
| Max Doppler shift | 0.000 045 ppm/s | 0.27 ppm/s (600 km) |
| variation (earth fixed | | 0.13 ppm/s (1200 km) |
| user equipment) | | |
| User equipment motion | 1200 km/h (e.g. aircraft) | 500 km/h (e.g. high speed |
| on the earth | | train) |
| | | Possibly 1200 km/h (e.g. |
| | | aircraft) |
| User equipment antenna | Omnidirectional antenna (linear polarisation), assuming 0 dBi | |
| types | Directive antenna (up to 60 cm equivalent aperture | |
| | diameter in circular polarisation) | |
| User equipment Tx | Omnidirectional antenna: UE power class 3 with up to 200 mW | |
| power | Directive antenna: up to 20 W | |
| User equipment Noise | Omnidirectional antenna: 7 dB | |
| figure | Directive antenna: 1.2 dB | |
| Service link | 3GPP defined New Radio | |
| Feeder link | 3GPP or non-3GPP defined | 3GPP or non-3GPP defined |
| | Radio interface | Radio interface |

NOTE 1:
Each satellite has the capability to steer beams towards fixed points on earth using beamforming techniques. This is applicable for a period of time corresponding to the visibility time of the satellite
NOTE 2:
Max delay variation within a beam (earth fixed user equipment) is calculated based on Min Elevation angle for both gateway and user equipment
NOTE 3:
Max differential delay within a beam is calculated based on Max beam foot print diameter at nadir
NOTE 4:
Speed of light used for delay calculation is 299792458 m/s.
NOTE 5:
The Maximum beam foot print size for GEO is based on current state of the art GEO High Throughput systems, assuming either spot beams at the edge of coverage (low elevation).
NOTE 6:
The maximum differential delay at cell level has been computed considering the one at beam level for largest beam size. It doesn't preclude that cell may include more than one beam when beam size are small or medium size. However the cumulated differential delay of all beams within a cell will not exceed the maximum differential delay at cell level in the table above.

The NTN study results apply to GEO scenarios as well as all NGSO scenarios with circular orbit at altitude greater than or equal to 600 km.

Hereinafter, the NTN reference point will be described.

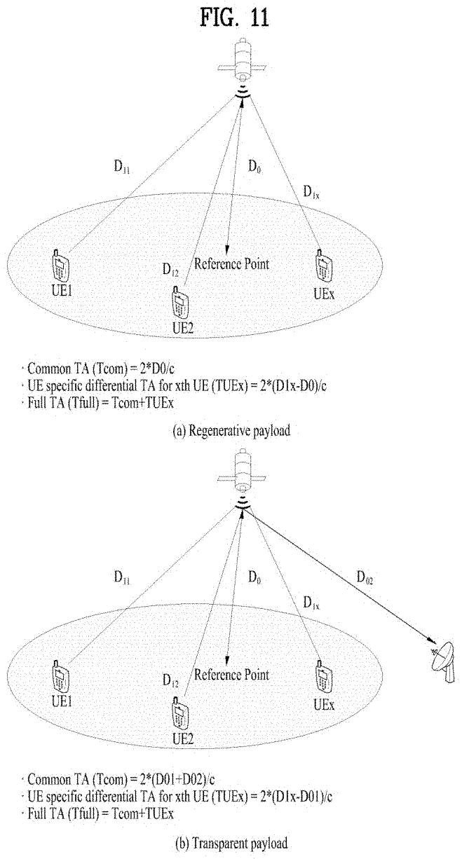

FIG. 11 illustrates TA components of the NTN. Here, the TA offset (NTAoffset) may not be plotted.

With consideration on the larger cell coverage, long round trip time (RTT) and high Doppler, enhancements are considered to ensure the performance for timing and frequency synchronization for UL transmission.

Referring to FIG. 11, a reference point related to timing advance (TA) of initial access and subsequent TA maintenance/management is illustrated. Terms defined in relation to FIG. 11 are described below.
Option 1: Autonomous acquisition of the TA at UE with UE known location and satellite ephemeris.

Regarding option 1, the required TA value for UL transmission including PRACH can be calculated by the UE. The corresponding adjustment can be done, either with UE-specific differential TA or full TA (consisting of UE specific differential TA and common TA).

W.r.t the full TA compensation at the UE side, both the alignment on the UL timing among UEs and DL and UL frame timing at network side can be achieved. However, in case of satellite with transparent payload, further discussion on how to handle the impact introduced by feeder link will be conducted in normative work. Additional needs for the network to manage the timing offset between the DL and UL frame timing can be considered, if impacts introduced by feeder link is not compensated by UE in corresponding compensation.

W.r.t the UE specific differential TA only, additional indication on a single reference point should be signalled to UEs per beam/cell for achieving the UL timing alignment among UEs within the coverage of the same beam/cell. Timing offset between DL and UL frame timing at the network side should also be managed by the network regardless of the satellite payload type.

With concern on the accuracy on the self-calculated TA value at the UE side, additional TA signalling from network to UE for TA refinement, e.g., during initial access and/or TA maintenance, can be determined in the normative work.
Option 2: Timing advanced adjustment based on network indication

Regarding option 2, the common TA, which refers to the common component of propagation delay shared by all UEs within the coverage of same satellite beam/cell, is broadcasted by the network per satellite beam/cell. The calculation of this common TA is conducted by the network with assumption on at least a single reference point per satellite beam/cell.

The indication for UE-specific differential TA from network as the Rel-15 TA mechanism is also needed. For satisfying the larger coverage of NTN, extension of value range for TA indication in RAR, either explicitly or implicitly, is identified. Whether to support negative TA value in corresponding indication will be determined in the normative phase. Moreover, indication of timing drift rate, from the network to UE, is also supported to enable the TA adjustment at UE side.

For calculation of common TA in the above two options, single reference point per beam is considered as the baseline. Whether and how to support the multiple reference points can be further discussed in the normative work.

For the UL frequency compensation, at least for LEO system, the following solutions are identified with consideration on the beam specific post-compensation of common frequency offset at the network side:
Regarding option 1, both the estimation and pre-compensation of UE-specific frequency offset are conducted at the UE side. The acquisition of this value can be done by utilizing DL reference signals, UE location and satellite ephemeris.
Regarding option 2, the required frequency offset for UL frequency compensation at least in LEO systems is indicated by the network to UE. The acquisition on this value can be done at the network side with detection of UL signals, e.g., preamble.

Indication of compensated frequency offset values by the network is also supported in case that compensation of the frequency offset is conducted by the network in the uplink and/or the downlink, respectively. However, indication of Doppler drift rate is not necessary.

Hereinafter, more delay-tolerant re-transmission mechanisms will be described in detail.

As follows, two main aspects of a retransmission mechanism with improved delay tolerance can be discussed.
Disabling of HARQ in NR NTN
HARQ optimization in NR-NTN

HARQ Round Trip Time in NR is of the order of several ms. The propagation delays in NTN are much longer, ranging from several milliseconds to hundreds of milliseconds depending on the satellite orbit. The HARQ RTT can be much longer in NTN. It was identified early in the study phase that there would be a need to discuss potential impact and solutions on HARQ procedure. RAN1 has focused on physical layer aspects while RAN2 has focused on MAC layer aspects.

In this regard, disabling of HARQ in NR NTN may be considered.

It was discussed that when UL HARQ feedback is disabled, there could be issues if (i) MAC CE and RRC signalling are not received by UE, or (ii) DL packets not correctly received by UE for a long period of time without gNB knowing it.

The following were discussed without convergence on the necessity of introducing such solutions for NTN when HARQ feedback is disabled
(1) Indicate HARQ disabling via DCI in new/re-interpreted field
(2) New UCI feedback for reporting DL transmission disruption and or requesting DL scheduling changes

The following possible enhancements for slot-aggregation or blind repetitions were considered. There is no convergence on the necessity of introducing such enhancements for NTN.
(1) Greater than 8 slot-aggregation
(2) Time-interleaved slot aggregation
(3) New MCS table

Next, a method for optimizing HARQ for the NR NTN will be described.

Solutions to avoid reduction in peak data rates in NTN were discussed. One solution is to increase the number of HARQ processes to match the longer satellite round trip delay to avoid stop-and-wait in HARQ procedure. Another solution is to disable UL HARQ feedback to avoid stop-and-wait in HARQ procedure and rely on RLC ARQ for reliability. The throughput performance for both types of solutions was evaluated at link level and system level by several contributing companies.

The observations from the evaluations performed on the effect of the number of HARQ processes on performance are summarized as follows:
Three sources provided link-level simulations of throughput versus SNR with the following observations:

One source simulated with a TDL-D suburban channel with elevation angle of 30 degrees with BLER target of 1% for RLC ARQ with 16 HARQ processes, and BLER targets 1% and 10% with 32/64/128/256 HARQ processes. There was no observable gain in throughput with increased number of HARQ processes compared to RLC layer re-transmission with RTT in {32, 64, 128, 256} ms.

One source simulated with a TDL-D suburban channel with elevation angle of 30 degrees with BLER targets of 0.10% for RLC ARQ with 16 HARQ processes, and BLER targets 1% and 10% with 32 HARQ processes. An average throughput gain of 10% was observed with 32 HARQ processes compared to RLC ARQ with 16 HARQ processes with RTT=32 ms.

One source provides the simulation results in following cases with RTT=32 ms, e.g., assuming BLER targets at 1% for RLC ARQ with 16 HARQ processes, BLER targets 1% and 10% with 32 HARQ processes. There is no observable gain in throughput with 32 HARQ processes compared to RLC ARQ with 16 HARQ processes in case that channel is assumed as TDL-D with delay spread/K-factor taken from system channel model in suburban scenario with elevation angle 30. Performance gain can be observed with other channels, especially, up to 12.5% spectral efficiency gain is achieved in case that channel is assumed as TDL-A in suburban with 30° elevation angle. Moreover, simulation based on the simulation with consideration on other scheduling operations: (i) additional MCS offset, (ii) MCS table based on lower efficiency (iii) slot aggregation with different BLER targets are conducted. Significant gain can be observed with enlarging the HARQ process number.

One source provided system level simulations for LEO=1200 km with 20% resource utilization, 16 and 32 HARQ processes, 15 and 20 UEs per cell, proportional fair scheduling, and no frequency re-use. The spectral efficiency gain per user with 32 HARQ processes compared to 16 HARQ processes depends on the number of UEs. With 15 UEs per beam, an average spectral efficiency gain of 12% at 50% per centile is observed. With 20 UEs per cell there is no observable gain.

The following options were considered with no convergence on which option to choose:
Option A: Keep 16 HARQ process IDs and rely on RLC ARQ for HARQ processes with UL HARQ feedback disabled via RRC
Option B: Greater than 16 HARQ process IDs with UL HARQ feedback enabled via RRC with following consideration. In this case, in the case of 16 or more HARQ process IDs, maintenance of a 4-bit HARQ process ID field in UE capability and DCI may be considered.

Alternatively, the following solutions may be considered for 16 or more HARQ processes keeping the 4-bit HARQ process ID field in DCI:
Option A: Keep 16 HARQ process IDs and rely on RLC ARQ for HARQ processes with UL HARQ feedback disabled via RRC
Option B: Greater than 16 HARQ process IDs with UL HARQ feedback enabled via RRC with following consideration. In this case, in the case of 16 or more HARQ process IDs, maintenance of a 4-bit HARQ process ID field in UE capability and DCI may be considered.

Alternatively, the following solutions may be considered for 16 or more HARQ processes keeping the 4-bit HARQ process ID field in DCI:

Slot Number Based

Virtual process ID based with HARQ re-transmission timing restrictions

Reuse HARQ process ID within RTD (time window)

Re-interpretation of existing DCI fields with assistance information from higher layers

One source also considered solutions where the HARQ process ID field is increased beyond 4 bits

With regards to HARQ enhancements for soft buffer management and stop-and-wait time reduction, the following options were considered with no convergence on which, if any, of the options, to choose:
Option A-1: Pre-active/pre-emptive HARQ to reduce stop-and-wait time
Option A-2: Enabling/disabling of HARQ buffer usage configurable on a per UE and per HARQ process
Option A-3: HARQ buffer status report from the UE

The number of HARQ processes with additional considerations for HARQ feedback, HARQ buffer size, RLC feedback, and RLC ARQ buffer size should be discussed further when specifications are developed.

The configurations (NR frame structure, NTN system, etc.) discussed above may be combined and applied in the contents described below, or may be supplemented to clarify the technical features of the methods proposed in the present disclosure.

Polarization Antenna

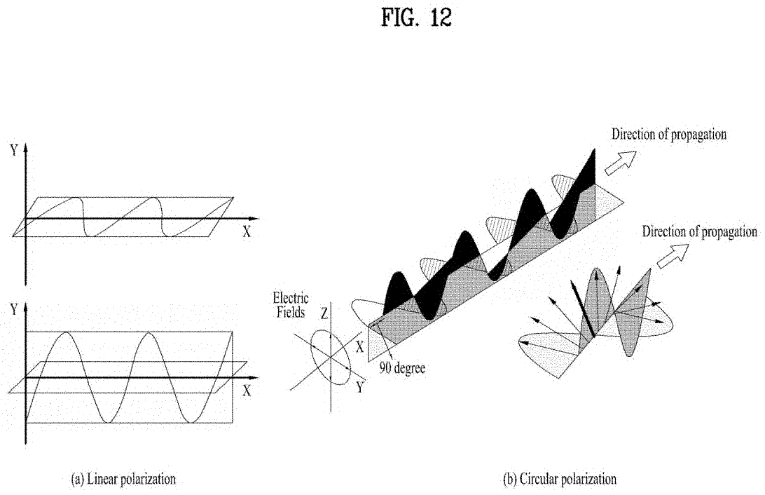

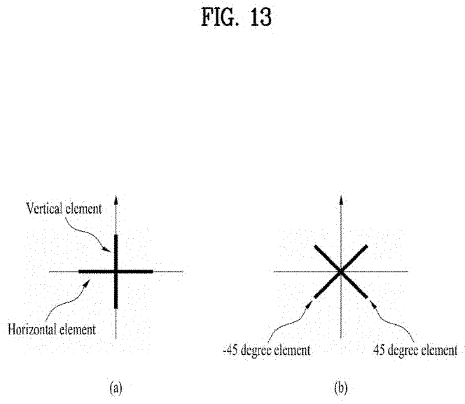

FIGS. 12 and 13 are diagrams for explaining polarization of an antenna.

In this document, the polarization (polarization) of an antenna means that the polarity direction of an electric field for the propagation direction of an electromagnetic wave is represented with respect to the ground surface.

Referring to FIG. 12, polarization is largely divided into two types: linear polarization and circular polarization.

The linear polarization is divided into horizontal polarization where the polarity of the electric field fluctuates in the direction horizontal to the ground surface and vertical polarization where the polarity of the electric field fluctuates in the direction perpendicular to the ground surface.

Referring to FIG. 12(b), the circular polarization has a shape in which the polarization plane moves in a spiral shape depending on time and propagation. A circular polarization signal may be generated as follows. For a cross-polarization antenna including vertical and horizontal antennas, the same signal is transmitted on each antenna, and a phase or time difference is given to the transmitted signals.

As shown in FIG. 12(b), a signal transmitted on the vertical antenna may be delayed by 90 degrees compared to a signal transmitted on the horizontal antenna. In this case, the polarization of a signal generated by combining the two transmitted signals rotates clockwise in the direction of propagation, which is referred to as right-handed circular polarization (RHCP). In contrast, when a signal transmitted on the vertical antenna is delayed by −90 degrees compared to a signal transmitted on the horizontal antenna, the polarization of a signal generated by combining the two transmitted signals rotates counterclockwise in the direction of propagation, which is referred to as left-handed circular polarization (LHCP).

If the time delay between a signal transmitted on the horizontal antenna and a signal transmitted on the vertical antenna has a value other than a multiple of 90 degrees, or when the magnitudes of signals transmitted on the two antennas do not match, the transmitted signals may have elliptical polarization.

Referring to FIG. 13(a), for a cross-polarization antenna composed of vertical and horizontal antennas, when the same signal is transmitted on each antenna, the polarization plane is tilted by 45 or −45 degrees. In this case, the polarization characteristics may be the same as or similar to those observed in a signal transmitted on a tilted cross-polarization antenna where vertical and horizontal antennas are tilted as shown in in FIG. 13(b).

Theoretically, for the cross-polarization antenna of FIG. 13(a), orthogonality is guaranteed between signals transmitted on the vertical and horizontal antennas so that there is no interference therebetween. That is, when the cross-polarization antenna of FIG. 13(a) is installed in a transmitter and receiver for communication therebetween, a signal transmitted on the vertical antenna of the transmitter is received only by the vertical antenna of the receiver, and a signal transmitted on the horizontal antenna of the transmitter is received only by the horizontal antenna of the receiver. Thus, there is no interference caused therebetween.

However, this phenomenon corresponds to a case where there is only a line of sight (LOS) link. In general, the polarization characteristics of a transmitted signal may change when the signal is reflected, refracted, or diffracted by a reflector or obstacle, and in this case, interference may occur between antennas. Generally, cross-polarization discrimination (XPD) is used as a metric for representing the degree (e.g., the degree of interference), where the XPD is defined as the ratio between power received with the same polarization antenna as that used by the transmitter and power received with the opposite polarization antenna. For a circular polarization signal, the rotation direction may change by reflection, refraction or diffraction.

Accordingly, by comparing the polarization characteristics of transmitted and received signals (i.e. a difference in received polarization angles, XPD, and/or polarization rotation directions), whether the signal is received through the LOS link with no reflection, refraction, or diffraction may be determined. In other words, the UE may obtain the polarization characteristics of a received signal by analyzing the characteristics of signals received on a cross-polarization antenna pair composed of vertical and horizontal antennas. Alternatively, the UE may receive only a signal having the same polarization characteristics as those of a transmitted signal to cancel a signal having modified polarization characteristics, which is received over multiple paths (i.e., NLOS link). Thus, the UE may accurately measure the propagation time of the LOS link.

Hereinafter, methods for effectively using polarization (LHCP/RHCP) depending on the rotation direction in a wireless communication environment including an NTN using the above-described circular polarization will be described.

Compared to the linear polarization, the circular polarization may be less sensitive to the Faraday Effect (for example, signal distortion caused by depolarization occurring when a signal passes through the atmosphere) related to the interaction of light and magnetic fields and more robust to signaling degradation depending on atmospheric conditions. Thus, high link reliability may be provided by the circular polarization.

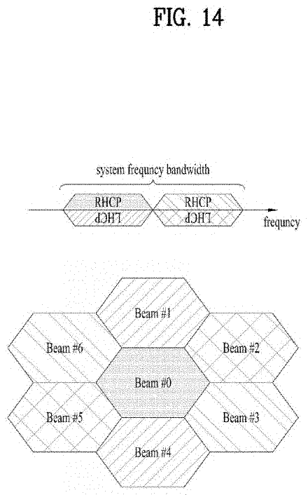

FIG. 14 is a diagram for explaining a scenario related to polarization reuse (see TR 38.821).

Referring to FIG. 14, a total of four orthogonal domains may be configured with frequency reuse 2 and polarization reuse 2. That is, one more polarization domain may be further used, compared to legacy LTE/NR where only frequency reuse is considered. In this case, there is an advantage that high flexibility may be provided in terms of network management.

(1) Proposal 1—Signal Classification According to Circular Polarization

To identify a signal (e.g., reference signal and/or channel) according to circular polarization, information on the polarization (e.g., RHCP/LHCP) may be included in sequence initialization. Signals related to Proposal 1 may include all or some of the following reference signals/channels.

1) CSI-RS: To identify a CSI-RS related to Proposal 1, it is proposed to distinguish sequence initialization by introducing a parameter (2^{M}λ), which is called lambda. In other words, the CSI-RS may be identified for each circular polarization by the sequence initialization according to Equation 3 below. Here, cᵢₙᵢₜ may be configured with a function of N_{symb}^{slot}n_{s,f}^{μ}, 1, n_{ID}, and λ.

cᵢₙᵢₜ=(2¹⁰(N_{symb}^{slot}n_{s,f}^{μ}+l+1)(2n_{ID}+1)+2^{M}λ+n_{ID})mod 2³¹ [Equation 3]

In Equation 3, λ may be preconfigured as 1 or 0 depending on whether the circular polarization is RHCP or LHCP. For example, when the circular polarization is related to RHCP, λ may be 1. When the circular polarization is related to LHCP, λ may be 0. Alternatively, when the circular polarization is related to RHCP, λ may be 0. When the circular polarization is related to LHCP, λ may be 1.

M is a positive integer other than negative integers (e.g., M=10), N_{symb}^{slot}n_{s,f}^{μ} is a slot number or index in a radio frame, 1 is an OFDM symbol number or index in a slot, and n_{ID} may have the same value as the value of a parameter scramblingID or sequenceGenerationConfig according to a higher layer signal. If there is no indication of the parameter, n_{ID} may have the same value as the cell ID for the UE. Alternatively, as an identifier for identifying the scrambling sequence, n_{ID} may be configured or determined as a value corresponding to an RS ID, a temporary ID (or RNTI) of the UE, etc.

The CSI-RS sequence may be generated based on the pseudo-random sequence as in Equation 1 described above.

2) DMRS for PBCH: For a DMRS for PBCH related to Proposal 1, sequence initialization may be identified by introducing the parameter (2^{M}λ), which is called lambda. In other words, the DMRS for PBCH may be identified for each circular polarization by the sequence initialization according to Equation 4 below. Here, cᵢₙᵢₜ may be configured with a function of i_{ssb}, N_{ID}, and λ.

cᵢₙᵢₜ=2¹¹(ī_{SSB}+1)(└N_{ID}^{cell}/4┘+1)+2⁶(ī_{SSB}+1)+(N_{ID}^{cell} mod 4)+2^{M}λ [Equation 4]

In Equation 4, λ may be preconfigured as 1 or 0 depending on whether the circular polarization is RHCP or LHCP. M is a positive integer other than negative integers (e.g., M=19).

In Equation 4, ī_{SSB} may be determined based on L̅_{Max}. Specifically, when L̅_{Max} is 4, ī_{SSB} may be determined by i_{SSB}+4n_{hf}. When L̅_{Max}>4, ī_{SSB} may correspond to i_{SSB}. Here, L̅_{Max} may be the maximum number of candidate SS/PBCH blocks in a half-frame, and n_{hf} is the index of a half-frame in which a PBCH is transmitted. In this case, n_{hf}=0 may correspond to the index of the first half-frame of a frame, and n_{hf}=1 may correspond to the index of the second half-frame of the frame. Also, i_{SSB} may correspond to the least significant two bits of the index of a candidate SS/PBCH block.

3) DMRS for PDCCH: For a DMRS for PDCCH related to Proposal 1, sequence initialization may be identified by introducing the parameter (2^{M}λ), which is called lambda. In other words, the DMRS for PDCCH may be identified for each circular polarization by the sequence initialization according to Equation 5 below. Here, cᵢₙᵢₜ may be configured with a function of N_{symb}^{slot}n_{s,f}^{μ}, 1, N_{ID}, and λ.

cᵢₙᵢₜ=(2¹⁷(N_{symb}^{slot}n_{s,f}^{μ}+l+1)(2N_{ID}+1)+2N_{ID}+2^{M}λ)mod 2³¹ [Equation 5]

In Equation 5, λ may be preconfigured as 1 or 0 depending on whether the circular polarization is RHCP or LHCP. M is a positive integer other than negative integers (e.g., M=30). In addition, n_{s,f}^{μ} is a slot number or index in a radio frame, and 1 is an OFDM symbol number or index in a slot. N_{ID} may be determined according to a higher layer parameter pdcch-DMRS-ScramblingID and be one of the following integers from 0 to 65535 (n_{ID}∈0, 1, . . . , 65535) Alternatively, when the parameter pdcch-DMRS-ScramblingID is not provided, N_{ID} may be set to a value corresponding to N_{ID}^{Cell}.

4) DMRS for PDSCH: In relation Proposal 1, a parameter called delta (δ) may be introduced to identify sequence initialization. In other words, the DMRS for PDSCH may be identified for each circular polarization by the sequence initialization according to Equation 6 below. Here, cᵢₙᵢₜ may be configured with a function of N_{symb}^{slot}n_{s,f}^{μ}, 1, n_{ID}, λ, δ, and N_{ID} [symbol] .

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} \vert \frac{\overline{λ}}{2} \vert + 2 {N}_{ID}^{{\overline{n}}_{SCID}^{\overline{λ}}} + {\overline{n}}_{SCID}^{\overline{λ}} + {2}^{M} δ ) mod {2}^{31} \qquad [ Equation 6 ]$$

In Equation 6, λ may be preconfigured as 1 or 0 depending on whether the circular polarization is RHCP or LHCP. M is a positive integer other than negative integers (e.g., M=30). In addition, n_{s,f}^{μ} is a slot number or index in a radio frame, and 1 is an OFDM symbol number or index in a slot. The remaining parameters in Equation 6 may be defined as shown in Table 8.

TABLE 8
- N_{ID}⁰, N_{ID}¹, ∈ {0,1, ... ,65535} are given by the higher-layer
parameters scramblingID0 and scramblingID1, respectively, in the
DMRS-DownlinkConfig IE if provided and the PDSCH is scheduled by
PDCCH using DCI format 1_1 or 1_2 with the CRC scrambled by
C-RNTI, MCS-C-RNTI, or CS-RNTI
- N_{ID}⁰ ∈ {0,1, ... ,65535} is given by the higher-layer parameter
scramblingID0 in the DMRS-DownlinkConfig IE if provided and the
PDSCH is scheduled by PDCCH using DCI format 1_0 with the CRC
scrambled by C-RNTI, MCS-C-RNTI, or CS-RNTI;
- N_{ID}ⁿ̅^{_{SCID}}^̅{̅^̅{̅λ̅}̅}̅ = N_{ID}^{cell} otherwise;
- n̅_{SCID}^̅{̅λ̅}̅ and λ̅ are given by
- if the higher-layer parameter dmrsDownlink-r16 in the
DMRS-DownlinkConfig IE is provided
${\overline{n}}_{SCID}^{\overline{λ}} = \{ \begin{matrix}{n}_{SCID} & λ = 0 or λ = 2 \\ 1 - {n}_{SCID} & λ = 1\end{matrix}$
λ̅ = λ
where λ is the CDM group defined in clause 7.4.1.1.2.
- otherwise by
n̅_{SCID}^̅{̅λ̅}̅ = n_{SCID}
λ̅ = 0
The quantity n_{SCID} ∈ {0, 1} is given by the DM-RS sequence initialization
field, if present, in the DCI associated with the PDSCH transmission if
DCI format 1_1 or 1_2 in [4, TS 38.212] is used, otherwise n_{SCID} = 0.

Sequences for the DMRSs may be generated by the pseudo-random sequence generator (Equation 1).

5) Positioning Reference Signal (PRS): In relation to Proposal 1, the parameter called lambda may be introduced to identify sequence initialization. In other words, the PRS may be identified for each circular polarization by the sequence initialization according to Equation 7 below. Here, cᵢₙᵢₜ may be configured with a function of n_{ID,seq}^{PRS}, N_{symb}^{slot}n_{s,f}^{μ}, 1, n_{ID} and λ.

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) + {2}^{μ} λ ) mod {2}^{31} \qquad [ Equation 7 ]$$

In Equation 7, λ may be preconfigured as 1 or 0 depending on whether the circular polarization is RHCP or LHCP. M is a positive integer other than negative integers (e.g., M=30). In addition, n_{s,f}^{μ} is a slot number or index in a radio frame, and 1 is an OFDM symbol number or index in a slot. The DL PRS sequence ID (n_{ID,seq}^{PRS}) may be given by a higher layer parameter DL-PRS-SequenceId (where, n_{ID,seq}^{PRS}∈0, 1, . . . , 4095).

6) PDSCH: In relation to Proposal 1, the parameter called lambda may be introduced to identify sequence initialization. In other words, the PDSCH may be identified for each circular polarization by the sequence initialization according to Equation 8 below. Here, cᵢₙᵢₜ may be configured with a function of n_{RNTI}, λ, q, and n_{ID}, and the sequence initialization may correspond to initialization of a scrambling sequence for the PDSCH.

cᵢₙᵢₜ=n_{RNTI}·2¹⁵+q·2¹⁴+n_{ID}+2^{M}λ [Equation 8]

In Equation 8, λ may be preconfigured as 1 or 0 depending on whether the circular polarization is RHCP or LHCP. M is a positive integer other than negative integers (e.g., M=29 or 30), and n_{ID} may be set to the same value as that of a higher layer parameter dataScramblingldentityPDSCH if dataScramblingIdentityPDSCH is provided (where n_{ID}∈0, 1, . . . 1023) In this case, the RNTI may be equal to the C-RNTI, MCS-C-RNTI, or CS-RNTI, and the transmission may not be scheduled using DCI format 1_0 in a common search space. Also, when two or more codewords are available for the transmission, q may be 0 or 1. When one codeword is available for the transmission, q may be 0.

7) PDCCH: In relation to Proposal 1, the parameter called lambda may be introduced to identify sequence initialization. In other words, the PDCCH may be identified for each circular polarization by the sequence initialization according to Equation q below. Here, cᵢₙᵢₜ may be configured with a function of n_{RNTI}, λ, and n_{ID}, and the sequence initialization may correspond to initialization of a scrambling sequence for the PDCCH.

cᵢₙᵢₜ=(n_{RNTI}·2¹⁶+N_{ID}+2^{M}λ)mod 2³¹ [Equation 9]

In Equation 8, λ may be preconfigured as 1 or 0 depending on whether the circular polarization is RHCP or LHCP. M is a positive integer other than negative integers (e.g., M=26 or 30).

For a UE-specific search space, when the higher layer parameter pdcch-DMRS-ScramblingID is provided, n_{ID} may be the same as pdcch-DMRS-ScramblingID. When pdcch-DMRS-ScramblingID is not provided, n_{ID} may be equal to N_{ID}^{cell}.

The sequence initialization for the PDCCH and PDSCH may be initialization of a scrambling sequence for the PDCCH and PDSCH.

(2) Proposal 2

According to Proposal 2, parts of existing cell IDs may be connected or mapped to information on polarization or circular polarization (e.g., RHCP/LHCP), without introducing the new parameter of Proposal 1. That is, the information on the polarization or circular polarization may be configured/indicated by cell ID information. For example, a method of dividing cell IDs (e.g., n_{ID}) of Proposal 1 into odd and even numbers and then mapping the divided parts to RHCP/LHCP or LHCP/RHCP may be considered. This mapping method may also be applied to a primary synchronization signal (PSS)/secondary synchronization signal (SSS). In this case, an SSB may also be identified according to RHCP/LHCP.

Alternatively, instead of dividing cell IDs into even and odd numbers, configurable cell IDs (e.g., 0 to 1023) may be divided in half Lower cell IDs may be mapped to LHCP (or RHCP), and higher cell IDs may be mapped to RHCP (or LHCP). For example, the first parts: 0 to 511 may be mapped to LHCP (or RHCP), and the remaining parts: 512 to 1023 may be mapped to RHCP (or LHCP).

According to the above proposals, a method of using LHCP/RHCP, which are polarization orthogonal domains in circular polarization, may also be applied to linear polarization. That is, the above proposals may be applied or extended to identify linear polarization related to “V-slant/H-slant” or “+45 degrees slant/−45 degrees slant”.

It is obvious that each of the examples of the proposed methods may also be included as one implementation method, and thus each of the examples may be regarded as a kind of proposed method. Although the proposed methods may be implemented independently, some of the proposed methods may be combined (or merged) for implementation. In addition, it may be regulated that information on whether the proposed methods are applied (or information on rules related to the proposed methods) should be transmitted from the BS to the UE in a predefined signal (e.g., a physical layer signal, a higher layer signal, etc.). Higher layers may include, for example, at least one of the following functional layers: MAC, RLC, PDCP, RRC, and SDAP.

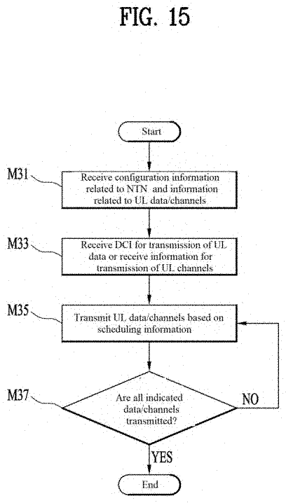

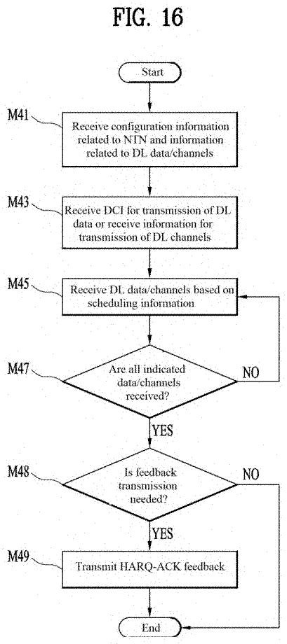

FIG. 15 is a flowchart illustrating a method for a UE to perform a UL transmission operation based on the above-described embodiments, and FIG. 16 is a flowchart illustrating a method for a UE to perform a DL reception operation based on the above-described embodiments.

The UE may perform NR NTN or LTE NTN transmission and reception of one or more physical channels/signals based on at least one of proposals 1 and 2 described above. Meanwhile, at least one step shown in FIGS. 15 and 16 may be omitted depending on circumstances or settings, and the steps shown in FIGS. 15 and 16 are only described for convenience of description and do not limit the scope of the present specification.

Referring to FIG. 15, the UE may receive configuration information related to an NTN and information related to UL data/UL channels (M31). Next, the UE may receive DCI/control information for transmission of the UL data and/or UL channels (M33). The DCI/control information may include scheduling information for transmission of the UL data/UL channels. Next, the UE may transmit the UL data/UL channels based on the scheduling information (M35). The UE may transmit the UL data/UL channels until all configured/indicated UL data/UL channels are transmitted. When all the UL data/UL channels are transmitted, the corresponding UL transmission operation may be ended (M37).

Referring to FIG. 16, the UE may receive configuration information related to an NTN and information related to DL data and/or DL channels (M41). Next, the UE may receive DCI/control information for reception of the DL data and/or the DL channels (M43). The DCI/control information may include scheduling information of the DL data/DL channels. The UE may receive the DL data/DL channels based on the scheduling information (M45). The UE may receive the DL data/DL channels until all configured/indicated DL data/DL channels are received, and when all DL data/DL channels are received, the UE may determine whether transmission of feedback information for the received DL data/DL channels is needed (M47 and M48). If it is necessary to transmit the feedback information, the UE may transmit HARQ-ACK feedback and, if not, the UE may end the reception operation without transmitting HARQ-ACK feedback (M49).

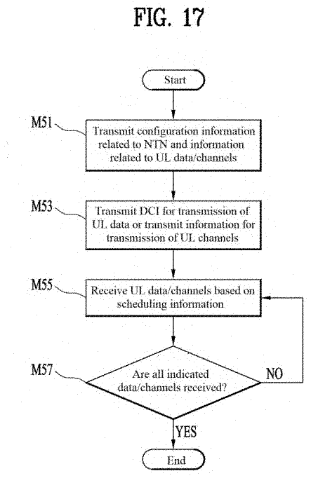

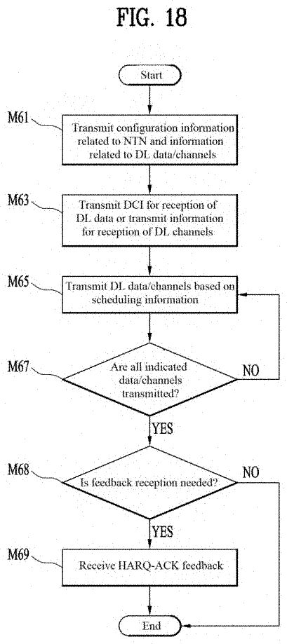

FIG. 17 is a flowchart illustrating a method for a BS to perform a UL reception operation based on the above-described embodiments, and FIG. 18 is a flowchart illustrating a method for a BS to perform a DL transmission operation based on the above-described embodiments.

The base station may perform NR NTN or LTE NTN transmission and reception of one or more physical channels/signals based on proposal 1, proposal 1-1, and/or proposal 2 described above. Meanwhile, at least one step shown in FIGS. 17 and 18 may be omitted depending on circumstances or settings, and the steps shown in FIGS. 17 and 18 are only described for convenience of description and do not limit the scope of the present specification.

Referring to FIG. 17, the BS may transmit configuration information related to an NTN and information related to UL data/UL channels to the UE (M51). Next, the BS may transmit DCI/control information for transmission of the UL data and/or UL channels (to the UE) (M53). The DCI/control information may include scheduling information for transmission of the UL data/UL channels. Next, the BS may receive the UL data/UL channels (from the UE) based on the scheduling information (M55). The BS may receive the UL data/UL channels until all configured/indicated UL data/UL channels are received. When all the UL data/UL channels are received, the corresponding UL reception operation may be ended (M57).

Referring to FIG. 18, the gNB may transmit configuration information related to an NTN and information related to DL data and/or DL channels (to the UE) (M61). Next, the BS may transmit DCI/control information for reception of the DL data and/or DL channels (M63). The DCI/control information may include scheduling information of the DL data/DL channels. The BS may transmit the DL data/DL channels (to the UE) based on the scheduling information (M65). The BS may transmit the DL data/DL channels until all configured/indicated DL data/DL channels are transmitted, and when all DL data/DL channels are transmitted, the BS may determine whether reception of feedback information for the DL data/DL channels is needed (M67 and M68). If it is necessary to receive the feedback information, the BS may receive HARQ-ACK feedback and, if not, the BS may end the DL transmission operation without receiving HARQ-ACK feedback (M69).

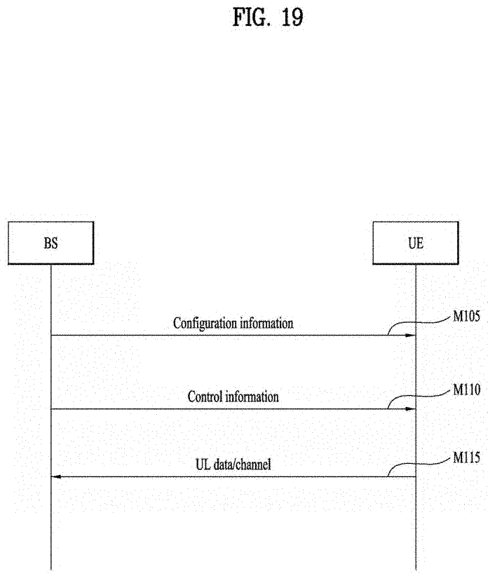

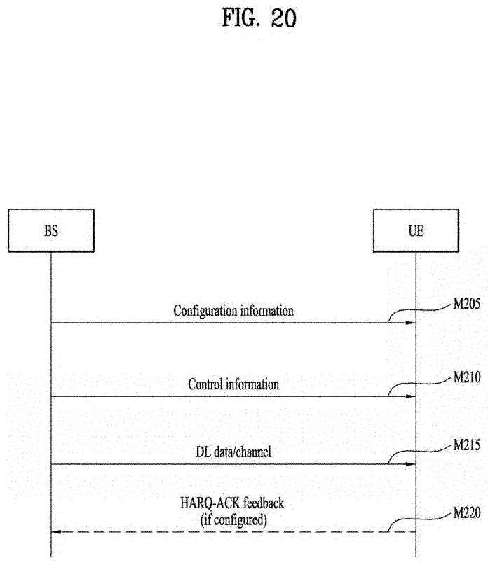

FIGS. 19 and 20 are flowcharts illustrating methods of performing signaling between a BS and a UE based on the above-described embodiments.

The base station and the U may perform NR NTN or LTE NTN transmission and reception of one or more physical channels/signals based on the above proposal 1, proposal 1-1, and/or proposal 2.

Referring to FIG. 19, the UE and the BS may perform a UL data/channel transmission/reception operation and, referring to FIG. 20, the UE and the BS may perform a DL data/channel transmission/reception operation.

Referring to FIG. 19, the BS may transmit configuration information to the UE (M105). That is, the UE may receive the configuration information from the BS.

Next, the BS may transmit the configuration information to the UE (M110). That is, the UE may receive the configuration information from the BS. For example, the configuration information may be transmitted/received through DCI. Alternatively, the configuration information may include control information for UL data/UL channel transmission and reception, scheduling information, resource allocation information, HARQ feedback-related information (e.g., an NDI, an RV, HARQ process number, a DL assignment index, a TPC command for a scheduled PUCCH resource indicator, and/or a PDSCH-to-HARQ FEEDBACK timing indicator), a modulation and coding scheme (MCS), and frequency domain resource assignment. Here, the DCI may be one of DCI format 1_0 and DCI format 1_1. Alternatively, the HARQ feedback-related information may be included in fields of the DCI.

According to the above-described proposals, the BS may initialize sequences of DL signals based on polarization information so that the DL signals are capable of being identified according to the polarization information. Alternatively, the BS may determine polarization information based on a cell ID and transmit the DL signals according to the determined polarization information. For example, the BS may transmit the DL signals in the rotation direction of circular polarization based on the sequence initialization or the cell ID.

Next, the BS may receive UL data/UL channels (e.g., a PUCCH/PUSCH) from the UE (M115). That is, the UE may transmit the UL data/UL channels to the BS. For example, the UL data/UL channels may be received/transmitted based on the above-described configuration information. Alternatively, the UL data/UL channels may be received/transmitted based on the above-described proposed methods. Alternatively, CSI reporting may be performed through the UL data/UL channels. The CSI reporting may be performed based on information such as RSRP/CQI/SINR/CRI. Alternatively, the UL data/UL channels may include a request/report of the UE related to HARQ feedback-enabled/disabled. For example, as described in the above proposed methods, HARQ feedback-enabled/disabled may be reported/requested based on a report on increase/decrease of an MCS and/or a report on increase/decrease of the repetition of the PDSCH.

Referring to FIG. 20, the BS may transmit configuration information to the UE (M205).

Next, the BS may transmit the configuration information to the UE (M210). That is, the UE may receive the configuration information from the BS. The configuration information may be transmitted/received through DCI. Alternatively, the configuration information may include control information for DL data/DL channel transmission and reception, scheduling information, resource allocation information, HARQ feedback-related information (e.g., an NDI, an RV, HARQ process number, a DL assignment index, a TPC command for a scheduled PUCCH resource indicator, and/or a PDSCH-to-HARQ_FEEDBACK timing indicator), an MCS, and frequency domain resource assignment. The DCI may be one of DCI format 1_0 and DC format 1_1.

Next, the BS may transmit DL data/DL channels (or a PDSCH) to the UE (M215). That is, the UE may receive the DL data/DL channels from the BS. The DL data/DL channels may be transmitted/received based on the above-described configuration information. For example, the DL data/DL channels may include a CSI-RS, a DMRS, a PRS, a PDSCH, etc. For example, the DL data/DL channels may be generated based on polarization. For example, information on polarization (e.g. RHCP/LHCP) may be included in sequence initialization of the DL data/DL channels. For example, the polarization information (e.g. RHCP/LHCP) may be based on a new parameter (e.g., λ, δ, etc.) and/or a cell ID.

Next, the BS may receive HARQ-ACK feedback from the UE (M220). That is, the UE may transmit HARQ-ACK feedback to the BS.

The BS may generically refer to an object that performs transmission and reception of data with the UE. For example, the BS may be a concept including one or more transmission points (TPs) or one or more transmission and reception points (TRPs). In addition, the TP and/or the TRP may include a panel or a transmission/reception unit of the BS. In addition, “TRP” may be replaced with expressions such as panel, antenna array, cell (e.g., macro cell/small cell/pico cell), TP, and BS (gNB). As described above, the TRP may be distinguished according to information (e.g., an index or ID) about a CORESET group (or CORESET pool). As an example, when one UE is configured to perform transmission/reception with a plurality of TRPs (or cells), this may mean that a plurality of CORESET groups (or CORESET pools) is configured for one UE. Such a configuration for the CORESET group (or CORESET pool) may be performed through higher layer signaling (e.g., RRC signaling).

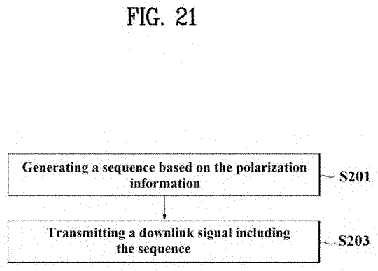

FIG. 21 is a flowchart for explaining a method in which an NTN transmits a DL signal.

The above-described polarization information may be information on a direction in which a signal is polarized, and more particularly, information on whether the polarization is linear polarization, LHCP, or RHCP. Hereinafter, the polarization information may correspond to the polarization direction or polarization.

Referring to FIG. 21, the NTN may generate a sequence initialized based on polarization information related to the DL signal (S201). The polarization information may be information on linear polarization or circular polarization as described above in FIGS. 13 and 14. The circular polarization may be classified into RHCP and LHCP. That is, the polarization information may include information on a direction in which the DL signal is polarized.

The sequence initialization may vary depending on the polarization information. Specifically, the sequence may be sequence-initialized according to Equation 3, Equation 4, Equation 5, Equation 6, Equation 7, Equation 8, or Equation 9, where parameter(s) for the polarization information are additionally reflected, so that the sequence may be identified based on the polarization information. That is, the sequence may be differentiated by the sequence initialization based on the polarization information.

In addition, the DL signal may include the sequence sequence-initialized by additionally reflecting the parameter related to the polarization information so that the DL signal may be identified based on the polarization information. That is, the DL signal may include the sequence that is sequence-initialized differently for each polarization direction, which depends on the polarization information. Accordingly, a UE may identify the polarization direction of the DL signal based on the sequence.

The DL signal may include an RS including the sequence initialized based on the polarization information as described above. In this case, the DL signal may be a PDCCH or PDSCH, and the RS may be a CSI-RS, a DMRS for PBCH, a DMRS for PDCCH, a DMRS for PDSCH, or a PRS.

As described above, the RS or DL signal may include the sequence sequence-initialized by additionally considering the polarization information or the parameter for the polarization direction. Specifically, when a CSI-RS is included in the DL signal, the CSI-RS may include a sequence initialized according to Equation 3. When the DL signal is a PBCH, the sequence of a DMRS included in the DL signal may be sequence-initialized according to Equation 4. When the DL signal is a PDCCH, the sequence may be initialized according to Equation 5, and when the DL signal is a PDSCH, the sequence may be initialized according to Equation 6. The sequence initialization for the PDCCH or PDSCH may be an operation of initializing a scramble sequence for the PDCCH or PDSCH.

The sequence of a PRS included in the DL signal may be sequence-initialized according to Equation 7. When the DL signal is a PDCCH, the sequence of the DL signal may be sequence-initialized according to Equation 8. When the DL signal is a PDSCH, the sequence of the DL signal may be sequence-initialized according to Equation 9.

As mentioned above, the parameter related to the polarization information (or polarization direction) may be reflected as 2^{M}λ or 2^{M}δ in the above equations. The value of λ or δ may be determined as 0 or 1 (or 0, 1, 2, or 3) depending on the polarization direction.

Based on the sequence initialization where the parameter related to the polarization information is reflected, each DL signal or each RS included in the DL signal may be identified according to the polarization information (or polarization direction).

Next, the NTN may transmit the DL signal including the sequence to the UE. The DL signal may be polarized in a direction corresponding to the polarization information or the polarization direction and transmitted to the UE. For example, the DL signal may be polarized in a rotation direction corresponding to RHCP or in a rotation direction corresponding to LHCP. In this case, since the sequence of the DL signal is initialized by additionally considering the polarization rotation direction (or polarization direction) as described above, the DL signal may be classified or identified according to the polarization information or polarization direction based on information about the sequence initialization.

Alternatively, the NTN may initialize a sequence for an SSB according to the polarization information and polarization direction. Specifically, the NTN may polarize and transmit the SSB including a PSS/SSS in a specific polarization direction. A sequence for the PSS/SSS may be initialized based on the parameter based on the polarization information corresponding to the polarization direction.

In this case, the NTN may determine the polarization information or polarization direction for the PSS/SSS or SSB based on its own cell ID. As described above, the NTN may determine whether the polarization direction or polarization information is RHCP or LHCP, based on whether its own cell ID is an even or odd number. Alternatively, half of the cell ID may be mapped to RHCP, and the other half may be mapped to LHCP. For example, when the cell ID consists of 0 to 1023, 0 to 511 may be mapped to LHCP, and 512 to 1023 may be mapped to RHCP. In this case, the polarization information on the PSS/SSS or SSB may be configured or determined as a default polarization direction for UEs performing initial access based on the SSB. In addition, the UE may determine the polarization information or polarization direction for the DL signal based on the cell ID and detect the sequence of the DL signal related to itself based on the polarization information or the parameter related to the polarization direction.

Hereinabove, the sequence initialization has been mainly described, but generation of the sequence related to the DL signal or the RS included in the DL signal may be found in TS 38.211.

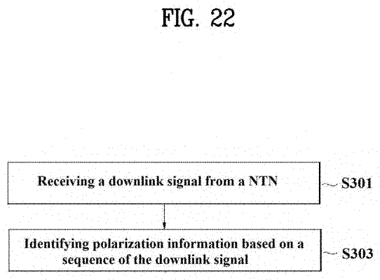

FIG. 22 is a flowchart for explaining a method in which a UE receives a DL signal.

Referring to FIG. 22, the UE may receive the DL signal from an NTN (S301). The DL signal may be polarized based on specific polarization information or in a specific polarization direction and then received. In this case, the polarization information or polarization direction is information on linear polarization or circular polarization as described above with reference to FIGS. 13 and 14, and the circular polarization may be divided into RHCP or LHCP. That is, the polarization information may include information about the direction in which the DL signal is polarized.

The DL signal may be polarized in a direction corresponding to the polarization information or the polarization direction and then transmitted to the UE. For example, the DL signal may be polarized in a rotation direction corresponding to RHCP or in a rotation direction corresponding to LHCP. In this case, since the sequence of the DL signal is initialized by additionally considering the polarization rotation direction (or polarization direction) as described above, the DL signal may be classified or identified according to the polarization information or polarization direction based on information about the sequence initialization.

Next, the UE may detect or determine whether the DL signal is polarized in a polarization direction related to the UE based on the sequence of the DL signal (S303). Specifically, the sequence of the DL signal may be sequence-initialized differently depending on the polarization information. In this case, the UE may determine whether the sequence of the DL signal is the sequence related to the UE based on a parameter related to polarization information related to the UE. For example, the UE may initialize the sequence according to any one of Equations 3 to 8 based on the polarization information related to the UE and then calculate correlation between the initialized sequence and the sequence of the DL signal. When the correlation is close to 1, the UE may determine that the DL signal is polarized in the polarization direction related to the UE. When the correlation is close to 0, the UE may determine that the DL signal is polarized in a direction opposite to the polarization direction related to the UE or the DL signal is not for the UE.

The UE may determine whether the DL signal is for the UE according to the following DL signal sequence initialization method. For example, the sequence of the DL signal may be sequence-initialized based on Equation 3, Equation 4, Equation 5, Equation 6, Equation 7, Equation 8, or Equation 9, where parameter(s) for the polarization information are additionally reflected, so that the sequence may be identified based on the polarization information. That is, the sequence may be differentiated by the sequence initialization based on the polarization information. Accordingly, the UE may identify the polarization direction of the DL signal based on the sequence initialization.

As described above, each RS or DL signal may include the sequence sequence-initialized by additionally considering the polarization information or the parameter for the polarization direction. Specifically, when a CSI-RS is included in the DL signal, the CSI-RS may include a sequence initialized according to Equation 3. When the DL signal is a PBCH, the sequence of a DMRS included in the DL signal may be sequence-initialized according to Equation 4. When the DL signal is a PDCCH, the sequence may be initialized according to Equation 5, and when the DL signal is a PDSCH, the sequence may be initialized according to Equation 6.

The sequence of a PRS included in the DL signal may be sequence-initialized according to Equation 7. When the DL signal is a PDCCH, the sequence of the DL signal may be sequence-initialized according to Equation 8. When the DL signal is a PDSCH, the sequence of the DL signal may be sequence-initialized according to Equation 9.

As mentioned above, the parameter related to the polarization information (or polarization direction) may be reflected as 2^{M}λ or 2^{M}δ in the above equations. The value of λ or δ may be determined as 0 or 1 (or 0, 1, 2, or 3) depending on the polarization direction.

Based on the sequence initialization where the parameter related to the polarization information is reflected, each DL signal or each RS included in the DL signal may be identified according to the polarization information (or polarization direction).

The UE may receive an SSB related to initial access from the NTN. As described above, a PSS/SSS included in the SSB may include a sequence initialized by additionally reflecting the polarization information or the parameter related to the polarization direction. In this case, the UE may acquire or determine the polarization information or polarization direction of the SSB based on a cell ID included in the SSB.

As described above, whether the polarization direction of the SSB is RHCP or LHCP may be mapped in advance depending on whether the cell ID is an odd or even number. In this case, if the cell ID related to the SSB is an even number, the UE may determine that the polarization direction of the SSB is RHCP. If the cell ID is an odd number, the UE may determine that the polarization direction of the SSB is LHCP. Alternatively, half of the cell ID may be mapped to RHCP, and the other half may be mapped to LHCP. For example, when the cell ID consists of 0 to 1023, 0 to 511 may be mapped to LHCP, and 512 to 1023 may be mapped to RHCP.

Meanwhile, the UE may set the polarization direction of the PSS/SSS or SSB as the default polarization direction assigned to the UE. That is, as described above, the UE may detect or identify whether the DL signal received based on the initialized sequence is for the UE, based on the default polarization direction.

Communication System Example to which the Present Disclosure is Applied

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

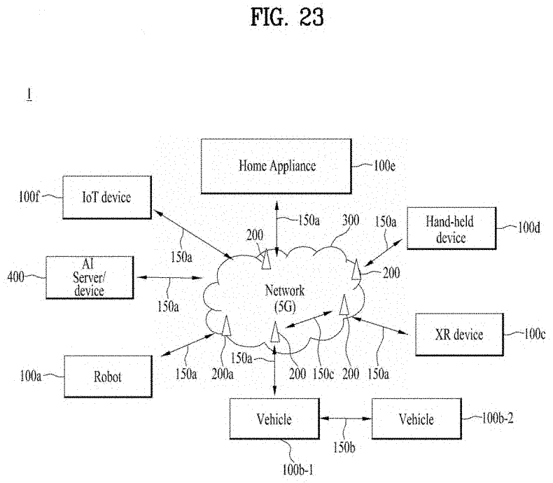

FIG. 23 illustrates a communication system applied to the present disclosure.

Referring to FIG. 23, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices to which the Present Disclosure is Applied

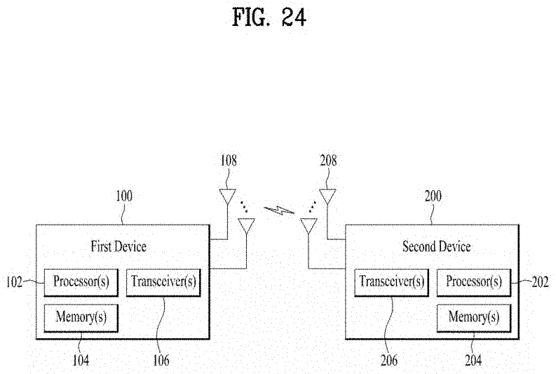

FIG. 24 illustrates a wireless device applicable to the present disclosure.

Referring to FIG. 24, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 23.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

According to an example, the first wireless device 100 or an NTN may include the processor(s) 102 connected to the RF transceiver and the memory(s) 104. The memory(s) 104 may include at least one program for performing operations related to the embodiments described with reference to FIGS. 13 to 22.

Specifically, the processor(s) 102 may be configured to generate a sequence related to a DL signal and control the RF transceiver to transmit the DL signal based on the sequence. The sequence may be sequence-initialized based on a parameter related to polarization information.

Alternatively, there may be provided a chipset including the processor(s) 102 and the memory(s) 104. In this case, the chipset may include at least one processor; and at least one memory operably connected to the at least one processor and configured to, when executed, cause the at least one processor to perform operations. The operations may include: generating a sequence related to a DL signal; and transmitting the DL signal based on the sequence. The sequence may be sequence-initialized based on a parameter related to polarization information. In addition, the at least one processor may be configured to perform operations related to the embodiments described with reference to FIGS. 13 to 22 based on a program included in the memory.

Alternatively, there may be provided a computer-readable storage medium including at least one computer program configured to cause at least one processor to perform operations. The operations may include: generating a sequence related to a DL signal; and transmitting the DL signal based on the sequence. The sequence may be sequence-initialized based on a parameter related to polarization information. In addition, the computer program may include a program for performing operations related to the embodiments described with reference to FIGS. 13 to 22.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

According to an embodiment, the second wireless device or a UE may include the processor(s) 202, the memory(s) 204, and/or the transceiver(s) 206 (or RF transceiver). The processor(s) 202 may be configured to control the RF transceiver to receive a DL signal from an NTN and identify polarization information on the DL signal based on a sequence sequence-initialized based on a parameter related to the polarization information. In addition, the processor(s) 202 may be configured to perform the above-described operations based on the memory(s) 204 including at least one program for performing operations related to the embodiments described with reference to FIGS. 13 to 22.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Application of Wireless Devices to which the Present Invention is Applied

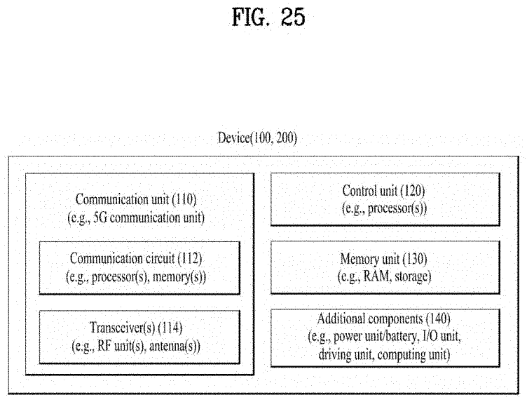

FIG. 25 illustrates another example of a wireless device applied to the present disclosure.

Referring to FIG. 25, wireless devices 100 and 200 may correspond to the wireless devices 100 and 200 of FIG. 24 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 24. For example, the transceiver(s) 114 may include the one or more transceivers 106 and 206 and/or the one or more antennas 108 and 208 of FIG. 24. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 23), the vehicles (100b-1 and 100b-2 of FIG. 23), the XR device (100c of FIG. 23), the hand-held device (100d of FIG. 23), the home appliance (100e of FIG. 23), the IoT device (100f of FIG. 23), a digital broadcast terminal, a hologram device, a public safety device, an MTC device, a medicine device, a fintech device (or a finance device), a security device, a climate/environment device, the AI server/device (400 of FIG. 23), the BSs (200 of FIG. 23), a network node, etc. The wireless device may be used in a mobile or fixed place according to a use-example/service.

In FIG. 25, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Here, wireless communication technologies implemented in the wireless devices (XXX, YYY) of the present specification may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology can generate personal area networks (PANs) related to small/low-power digital communication based on various standards such as IEEE 802.15.4, and may be called various names.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure.

### INDUSTRIAL APPLICABILITY

The above-described embodiments of the present disclosure are applicable to various mobile communication systems.

1. A method of transmitting, by a non-terrestrial network (NTN), a downlink signal in a wireless communication system, the method comprising:
generating a sequence related to the downlink signal; and
transmitting the downlink signal based on the sequence,
wherein the downlink signal includes at least one a DMRS (Demodulate Reference Signal) and a CSI-RS (channel state information reference signal),
wherein the DMRS or the CSI-RS includes the sequence sequence-initialized based on a parameter related to polarization information.

2. The method of claim 1, wherein the polarization information is information on one of linear polarization, right-handed circular polarization (RHCP), and left-handed circular polarization (LHCP).

3. The method of claim 1, wherein the sequence is sequence-initialized based on the parameter related to the polarization information, 2^{M}λ, where λ is determined as 0 or 1 depending on the polarization information, and M is a positive integer.

4. The method of claim 1, wherein the CSI RS included in the downlink signal is generated based on the sequence sequence-initialized according to the following equation:
cᵢₙᵢₜ=(2¹⁰(N_{symb}^{slot}n_{s,f}^{μ}+l+1)(2n_{ID}+1)+2^{M}λ+n_{ID})mod 2³¹,
where λ is determined as 0 or 1 depending on the polarization information, N_{symb}^{slot}n_{s,f}^{μ} is a slot index, n_{ID} is an identification value for sequence identification, and 1 is an index of an orthogonal frequency division multiplexing (OFDM) symbol.

5. The method of claim 4, wherein M is 10 or 11.

6. The method of claim 1, wherein the downlink signal is
a physical broadcast channel (PBCH),
a physical downlink control channel (PDCCH),
or a physical downlink shared channel (PDSCH).

7. The method of claim 1, wherein the downlink signal comprises a positioning reference signal (PRS) including the sequence initialized based on the parameter related to the polarization information.

8. The method of claim 1, wherein the NTN is configured to determine the polarization information on the downlink signal based on a cell identifier (ID) related to the NTN.

9. The method of claim 8, further comprising transmitting a primary synchronization signal (PSS) and a secondary synchronization signal (SSS),
wherein the PSS and the SSS include the sequence sequence-initialized based on the parameter related to the polarization information related to the cell ID.

10. A method of receiving, by a user equipment (UE), a downlink signal from a non-terrestrial network (NTN) in a wireless communication system, the method comprising:
receiving the downlink signal from the NTN; and
obtaining polarization information based on a DMRS (Demodulate Reference Signal) or a CSI-RS (channel state information reference signal) included in the downlink signal,
wherein the polarization information is obtained based on a parameter for sequence-initialization related to a sequence included in the DMRS or the CSI-RS.

11. The method of claim 10, wherein the downlink signal is polarized based on one of linear polarization, right-handed circular polarization (RHCP), and left-handed circular polarization (LHCP).

12. A non-terrestrial network (NTN) configured to transmit a downlink signal in a wireless communication system, the NTN comprising:
a radio frequency (RF) transceiver; and
a processor connected to the RF transceiver,
wherein the processor is configured to:
generate a sequence related to the downlink signal; and
control the RF transceiver to transmit the downlink signal based on the sequence, and
wherein the downlink signal includes at least one a DMRS (Demodulate Reference Signal) and a CSI-RS (channel state information reference signal),
wherein the DMRS or the CSI-RS includes the sequence sequence-initialized based on a parameter related to polarization information.

13-15. (canceled)
